(19) United States
(12) Patent Application Publication
(10) Pub. No.: US 2022/0365588 A1
(43) Pub. Date: Nov. 17, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: KENTA NAKASHIMA, TOKYO (JP)

(21) Appl. No.: 17/638,018

(22) PCT Filed: Aug. 4, 2020
(86) PCT No.: PCT/JP2020/029762

§ 371 Date: Feb. 24, 2022

(30) Foreign Application Priority Data
Sep. 4, 2019 (JP) 2019-161146

(51) Int. Cl. G06F 3/01; G06T 11/00

(52) U.S. Cl. CPC G06F 3/011; G06T 11/00

(57) ABSTRACT

An information processing apparatus according to an embodiment of the present technology includes: a display control unit. The display control unit controls, on the basis of space-related information regarding a real space, display of an association image on the real space, the association image making it possible for a person in the real space to understand association of the person with an object in the real space and how the object is affected by movement of the person. As a result, it is possible to clarify a relationship between the person and the object, clarify mobility characteristics, realize interaction between a physical object and a virtual space, and thus realize new user experience.

### TECHNICAL FIELD

The present technology relates to an information processing apparatus, an information processing method, and a program that are capable of controlling display of an image.

### BACKGROUND ART

Patent Literature 1 discloses a content providing system that provides content to a user. In this content providing system, a target user is specified on the basis of the type of the content. The orientation of the display surface displaying content is controlled such that the display surfaces faces the specified target user. As a result, it is possible to inform the user of that the displayed content is intended for the user himself/herself (paragraphs [0036] to [0038] in the specification of Patent Literature 1, and the like).

### CITATION LIST

### Patent Literature

Patent Literature 1: Japanese Patent Application Laid-open No. 2017-69865

### DISCLOSURE OF INVENTION

### Technical Problem

For example, there is a demand for the technology making it possible to provide new user experience (UX) to a user who views an image such as a content image.

In view of the circumstances as described above, it is an object of the present technology to provide an information processing apparatus, an information processing method, and a program that are capable of realizing new user experience.

### Solution to Problem

In order to achieve the above-mentioned object, an information processing apparatus according to an embodiment of the present technology includes: a display control unit.

The display control unit controls, on the basis of space-related information regarding a real space, display of an association image on the real space, the association image making it possible for a person in the real space to understand association of the person with an object in the real space and how the object is affected by movement of the person.

In this information processing apparatus, display of an association image is controlled, the association image making it possible for a person to understand association of the person with an object and how the object is affected by movement of the person. As a result, it is possible to realize new user experience.

The space-related information may include movement information regarding the movement of the person in the real space. In this case, the display control unit may control the display of the association image on the basis of the movement information.

The information processing apparatus may further include a determination unit that determines an instruction from the person in the real space. In this case, the image display unit may control the display of the association image on the basis of the instruction.

The association image may include a string-shaped image displayed so as to connect the person and the object with each other.

The string-shaped image may be an image imitating an actual string object having a defined length.

The space-related information may include position information of the person and position information of the object. In this case, the display control unit may control a display mode of the string-shaped image on the basis of a distance between the person and the object.

The display control unit may display the string-shaped image such that the string-shaped image is tighter as the distance between the person and the object increases and display the string-shaped image such that the string-shaped image is looser as the distance between the person and the object decreases.

The space-related information may include position information of the person and position information of the object. In this case, the display control unit may calculate, on the basis of a position of the person and a position of the object, a position of a first endpoint of the string-shaped image on a side of the person and a position of a second endpoint of the string-shaped image on a side of the object, and display the string-shaped image such that the first endpoint and the second endpoint are connected to each other.

The object may include an object image that is an image displayed in the real space. In this case, the display control unit may be capable of controlling display of the object image and may cause, where the person has moved in a direction away from the object image while the string-shaped image is fully stretched, the object image to move so as to follow the movement of the person.

The display control unit may cause the object image to move on the basis of the movement of the person operating the string-shaped image.

The information processing apparatus may further include a processing execution unit that executes processing regarding the object associated with the person.

The information processing apparatus may further include a determination unit that determines an instruction from the person in the real space. In this case, the processing execution unit may execute, on the basis of the instruction from the person in the real space, processing regarding the object associated with the person who has input the instruction.

The space-related information may include apparatus information regarding an electronic apparatus in the real space. In this case, the object may include an object image that is an image displayed in the real space. Further, the processing execution unit may control the electronic apparatus on the basis of the movement of the person operating the string-shaped image to superimpose the object image on the electronic apparatus.

The electronic apparatus may include a display device. In this case, the processing execution unit may cause, on the basis of the movement of superimposing the object image on the display device, the display device to display an image regarding the object image.

The space-related information may include object information regarding an object in the real space. In this case, the display control unit may display, in the real space, the object information regarding the object associated with the person.

The space-related information may include apparatus information regarding an electronic apparatus in the real space. In this case, the display control unit may display, in the real space, an image regarding the electronic apparatus as the object associated with the person, on the basis of movement of causing a tip of the string-shaped image displayed so as to connect the person and the electronic apparatus to each other to move from the electronic apparatus to another position.

The object may include an object image that is an image displayed in the real space. In this case, the display control unit may collectively display, where a distance between a first person and a second person in the real space is smaller than a predetermined threshold value, a first object image associated with the first person and a second object image associated with the second person.

The display control unit may be capable of controlling, where a plurality of objects is associated with the person, display of a plurality of string-shaped images connecting the person and the plurality of objects to each other. In this case, the object may include an object image that is an image displayed in the real space. Further, the display control unit may display, in the real space, integrated information regarding the first object image and the second object image as the object associated with the person, on the basis of the movement of the person operating the plurality of string-shaped images to superimpose the first object image and the second object image associated with the person on each other.

An information processing method according to an embodiment of the present technology is an information processing method executed by a computer system, including: controlling, on the basis of space-related information regarding a real space, display of an association image on the real space, the association image making it possible for a person in the real space to understand association of the person with an object in the real space and how the object is affected by movement of the person.

A program according to an embodiment of the present technology causes a computer system to execute the following step of:

controlling, on the basis of space-related information regarding a real space, display of an association image on the real space, the association image making it possible for a person in the real space to understand association of the person with an object in the real space and how the object is affected by movement of the person.

### BRIEF DESCRIPTION OF DRAWINGS

FIG. 1 is a schematic diagram describing an example of an image display system according to the present technology.

FIG. 2 is a block diagram showing a functional configuration example of an image display system and an information processing apparatus.

FIG. 3 is a flowchart showing an operation example of the information processing apparatus.

FIG. 4 is a flowchart showing a processing example when newly displaying a string image.

FIG. 5 is a schematic diagram showing a display example of a string image.

FIG. 6 is a flowchart showing a processing example of association according to an instruction to display a content image.

FIG. 7 is a flowchart showing a processing example when deleting a string image.

FIG. 8 is a schematic diagram describing follow-up of an object image.

FIG. 9 is a flowchart showing a specific processing example of follow-up control of an object image.

FIG. 10 is a schematic diagram describing a display restriction area.

FIG. 11 is a schematic diagram showing movement of an object image 7 as an operation example of a string image.

FIG. 12 is a schematic diagram describing a control example of an interlocking device by operating a string image.

FIG. 13 is a schematic diagram describing an example of operating an object other than the electronic apparatus.

FIG. 14 is a flowchart showing a processing example according to an operation from an object image to a physical object.

FIG. 15 is a schematic diagram describing an operation of a string image to which an electronic apparatus is connected.

FIG. 16 is a flowchart showing a processing example according to an operation of a string image to which an object is connected.

FIG. 17 is a schematic diagram describing collective display of a plurality of object images.

FIG. 18 is a flowchart showing a processing example of collective display.

FIG. 19 is a schematic diagram describing display of integrated information.

FIG. 20 is a block diagram showing a hardware configuration example of the information processing apparatus.

### MODE(S) FOR CARRYING OUT THE INVENTION

Hereinafter, an embodiment according to the present technology will be described with reference to the drawings.

[Image Display System]

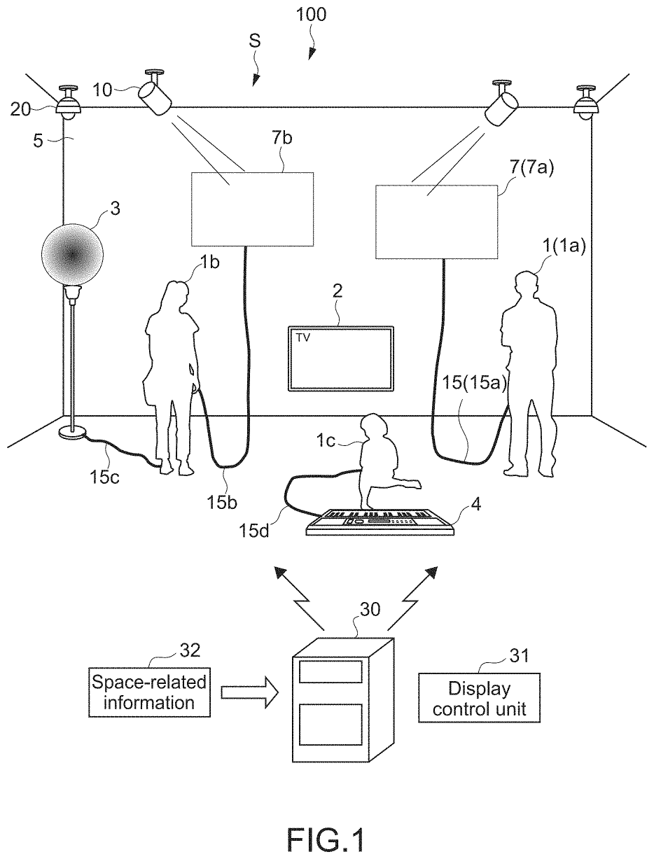

An example of an image display system according to the present technology will be described with reference to FIG. 1.

In an image display system 100 according to the present technology, it is possible to realize new user experience that has never existed by controlling display of an image.

The image display system 100 according to the present technology is typically constructed in a real space S. The real space can be referred to also as a physical space.

As the real space S, an arbitrary real space such as a room such as a living room and an indoor space in a facility such as a gymnasium can be adopted. It goes without saying that the image display system 100 according to the present technology does not necessarily need to be constructed in the indoor space and can be constructed in an outdoor space where a screen or the like capable of display an image on a plaza, a parking lot, or the like, is disposed.

In the example shown in FIG. 1, the image display system 100 is constructed in a space, as the real space S, in a room including a wall surface 5.

The image display system 100 includes an image display unit 10, a sensor unit 20, and an information processing apparatus 30.

The image display unit 10, the sensor unit 20, and the information processing apparatus 30 are wired or wirelessly connected to each other so as to be communicable with each other. The connection form between the respective devices is not limited, and wireless LAN communication such as WiFi or short-range wireless communication such as Bluetooth (registered trademark) can be used.

The image display unit 10 is capable of displaying an image on the real space S. For example, the image display unit 10 is configured so that an image can be displayed on the wall surface 5, the floor, the ceiling, or the like shown in FIG. 1.

As the image display unit 10, for example, a projector capable of projecting an image on the wall surface 5 or the like is used. The specific configuration, number, arrangement position, and the like of the projector are not limited, and the projector may be arbitrarily designed so that an image can be projected on a desired area within the real space S.

For example, a movable projector or a free-viewpoint projector may be used.

In addition, the configuration of the image display unit 10 is not limited, and may be arbitrarily designed. For example, the image display unit 10 is not limited to a device that projects an image, and a display device such as a transparent display may be installed on the wall surface 5 or the like.

The sensor unit 20 is capable of detecting various types of data regarding the real space S.

As the sensor unit 20, an imaging apparatus such as a digital camera, a ToF (Time of Flight) camera, a stereo camera, a monocular camera, an infrared camera, a polarized camera, and another camera is disposed. Further, a sensor device such as a laser distance measuring sensor, a contact sensor, an ultrasonic sensor, a LiDAR (Light Detection and Ranging, Laser Imaging Detection and Ranging), and a sonar may be used.

Further, as the sensor unit 20, various microphones capable of detecting the sound generated in the real space S are disposed. Further, a GPS or the like may be disposed. In addition, the configuration of the sensor unit 20 is not limited, and the sensor unit 20 may be arbitrarily designed.

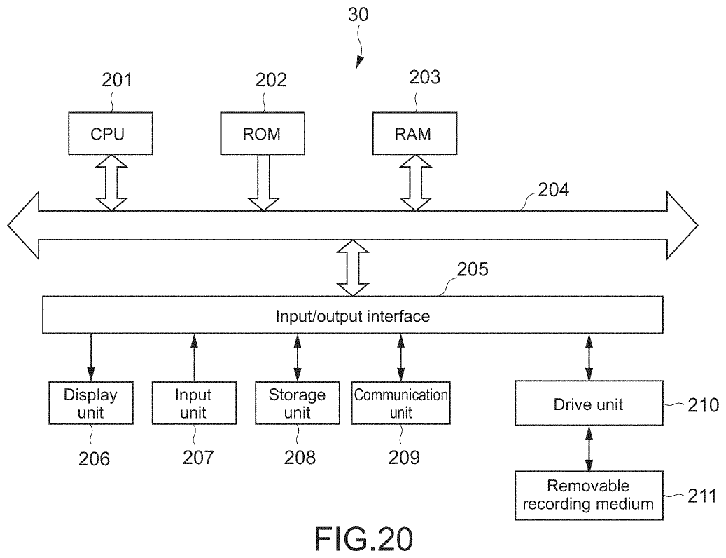

The information processing apparatus 30 includes hardware necessary for configuring a computer, such as a processor such as a CPU and a GPU, a memory such as a ROM and a RAM, and a storage device such as an HDD (see FIG. 20). For example, the CPU loads the program according to the present technology stored in the ROM or the like in advance in the RAM and executes the program, thereby executing an information processing method according to the present technology.

For example, the information processing apparatus 30 can be realized by an arbitrary computer such as a PC (Personal Computer). It goes without saying that hardware such as FPGA and ASIC may be used.

In this embodiment, when the CPU executes a predetermined program, a display control unit 31 as a functional block is configured. It goes without saying that dedicated hardware such as an IC (integrated circuit) may be used in order to realize a functional block.

The program is installed in the information processing apparatus 30 via, for example, various recording media. Alternatively, the program may be installed via the Internet or the like.

The type and the like of the recording medium on which a program is recorded is not limited, and an arbitrary computer-readable recording medium may be used. For example, an arbitrary non-transient computer-readable storage medium may be used.

The information processing apparatus 30 acquires space-related information 32. Note that in the present disclosure, the acquisition of the space-related information 32 includes both receiving the space-related information 32 transmitted from the outside and generating the space-related information 32 by the information processing apparatus 30 itself.

The space-related information 32 includes arbitrary information regarding the real space S such as environment information, person information, and object information as exemplified below.

“Environment Information”

For example, position information of an object configuring the real space S and identification information for identifying the type of the object, or position information of the object present in the real space S and identification information for identifying the type of the object are acquired as the environment information.

Note that the “object” is a concept including the “person”. Meanwhile, in the present disclosure, a person and an object that is not a person are distinguished from each other for description in many cases. Therefore, in the following, an object that is not a person will be described simply as an object in some cases. Further, an object can be referred to also as a physical object.

The position information is defined by, for example, coordinate values based on the coordinate system set in the real space S. For example, an absolute coordinate system (world coordinate system) may be used, or a relative coordinate system with a predetermined point as a reference (origin) may be used. In the case of using a relative coordinate system, the origin used as a reference may be arbitrarily set.

Map information regarding the real space S is included in the environment information.

In the example shown in FIG. 1, identification information for identifying the wall surface 5, the floor, the ceiling, and the like configuring the real space S, position information, and the like are acquired as the environment information.

Further, in the example shown in FIG. 1, electronic apparatuses, i.e., a television set 2, a lighting apparatus 3, and an electronic piano 4, are disposed in the real space S. Identification information for identifying each of these electronic apparatuses and position information of each of the electronic apparatuses are acquired as the environment information.

“Person Information”

For example, various types of information regarding a person present in the real space S are acquired as the person information.

For example, various types of information regarding the state of a person are included in the person information. For example, identification information for identifying a person, position information of the person, movement information of the person, utterance information of the person, the posture of the person, the line of sight of the person, and the facial expression of the person are included in the person information.

Further, various instructions input by the person are also included in the person information. For example, the content of the instruction input via voice, movement (gesture), posture, facial expression, or the like is acquired as the person information.

In the example shown in FIG. 1, three persons 1 (1a to 1c) are present in the real space S. Identification information for identifying the person 1 movement of the person 1, and an instruction from the person 1 are acquired as the person information.

The person 1 present in the real space S corresponds to a user of this image display system 100. Therefore, the person information can be referred to also as user information.

“Object Information”

For example, arbitrary information regarding an object (object that is not a person) present in the real space S is acquired as the object information.

For example, information regarding the function, status, and controllability of an electronic apparatus present in the real space S is acquired as the object information. The information regarding an electronic apparatus can be referred to also as apparatus information.

Further, an object that is not an electronic apparatus, e.g., arbitrary information regarding a foliage plant, a table, a food material, or the like is acquired as the object information.

The space-related information 32 including environment information, person information, object information, and the like may be prepared in advance and stored, for example. Alternatively, the space-related information 32 may be generated in real time on the basis of the detection result of the sensor unit 20. Further, the space-related information 32 is acquired by referring to the information generated on the basis of the detection result of the sensor unit 20 and to table information stored in advance or the like, in some cases. In addition, an arbitrary technology (algorithm or the like) for acquiring the space-related information 32 may be adopted.

For example, an arbitrary machine-learning algorithm using a DNN (Deep Neural Network) or the like may be used. For example, by using AI (artificial intelligence) or the like that performs deep learning, it is possible to improve generation accuracy of the space-related information 32.

For example, a learning unit and an identification unit are constructed for generating the space-related information 32. The learning unit performs machine learning on the basis of input information (learning data) and outputs the learning result. Further, the identification unit identifies (determines, predicts, etc.) the input information on the basis of the input information and the learning result.

For example, a neural network or deep learning is used as the learning method in the learning unit. The neural network is a model that imitates a brain neural circuit of a human and includes three types of layers, i.e., an input layer, an intermediate layer (hidden layer), and an output layer.

The deep learning is a model that uses a neural network having a multilayer structure, and is capable of repeating characteristic learning in each layer and learning complex patterns hidden in a large amount of data.

The deep learning is used to, for example, identify an object in an image and a word in voice. It goes without saying that the deep learning can be applied to the generation of the space-related information 32 according to this embodiment.

Further, as a hardware structure for realizing such machine learning, a neurochip/neuromorphic chip incorporating the concept of a neural network can be used.

The problem setting in machine learning includes supervised learning, unsupervised learning, semi-supervised learning, reinforcement learning, inverse reinforcement learning, active learning, and transfer learning.

For example, in the supervised learning, a feature amount is learned on the basis of given labeled learning data (teaching data). As a result, it is possible to derive a label of unknown data.

Further, in the unsupervised learning, a large amount of unlabeled learning data is analyzed to extract a feature amount, and clustering is performed on the basis of the extracted feature amount. As a result, it is possible to analyze trends and predict the future on the basis of a huge amount of unknown data.

Further, the semi-supervised learning is a mixture of the supervised learning and the unsupervised learning, and is a method of giving a huge amount of training data by the unsupervised learning after learning a feature amount by the supervised learning and repeatedly performing learning while automatically calculating a feature amount.

Further, the reinforcement learning deals with the problem that an agent in an environment observes the current state and determines what action to take. The agent obtains a reward from the environment by selecting an action and learns how to obtain the most rewards through a series of actions. By learning the optimal solution in an environment as described above, it is possible to reproduce the judgment of a human and cause a computer to learn judgment exceeding that of the human.

It is also possible to generate virtual sensing data by machine learning. For example, it is possible to predict sensing data from other sensing data and use the predicted sensing data as input information, e.g., it is possible to generate position information from the input image information.

Further, it is possible to generate different sensing data from a plurality of pieces of sensing data. Further, it is also possible to predict necessary information and generate predetermined information from sensing data.

Further, an arbitrary learning algorithm or the like different from machine learning may be used. By generating the space-related information 32 in accordance with a predetermined learning algorithm, it is possible to generation accuracy of the space-related information 32. It goes without saying that the present technology is not limited to the case of using a learning algorithm.

Note that the application of a learning algorithm may be performed on arbitrary processing in the present disclosure.

As a method of generating person information, skeleton estimation may be executed. The skeleton estimation is referred to also as bone estimation or skeleton estimation, and may be executed using a well-known technology. The skeleton estimation makes it possible to determine the posture of a person, or the like with high accuracy. For example, it is possible to detect also the direction in which the arm is stretched, the direction in which the wrist is switched, the direction in which the leg is raised up, and the like.

The display control unit 31 of the information processing apparatus 30 illustrated in FIG. 1 is capable of controlling, on the basis of the space-related information 32, the display of an image by the image display unit 10 disposed in the real space S.

For example, the display control unit 31 calculates, on the basis of the space-related information 32, a display position (e.g., a coordinate value) of an image. Then, the display control unit 31 displays a predetermined image at the calculated display position.

In the present disclosure, the image includes a still image and a moving image. It goes without saying that a plurality of frame images included in the moving image is included in the image.

Examples of the type of the displayed image include the following types.

“Content Image”

For example, an image displaying content such as a movie and a TV program is included.

“Virtual Object Image”

For example, an image virtually displaying an actual object or the like is included.

“Information Presentation Image”

For example, an image displaying various types of information is included. An image including a Web page or the like displayed via a Web browser is also included in the information presentation image.

“Apparatus Control Image”

For example, an image indicating the control of an electronic apparatus is included. For example, an image displaying arbitrary control (command) on an electronic apparatus, such as “volume up” and “power ON” is displayed as the apparatus control image. Further, an image or the like displaying the status of an electronic apparatus is included in the apparatus control image.

In addition various types of images are displayed. Further, the classification of images described above is merely an example, and the present technology is not limited to the case where images are classified on the basis of such classification.

[Association Image]

Further, in this embodiment, display of an association image according to the present technology on the real space S is controlled by the display control unit 31.

The association image according to the present technology is an image making it possible for the person 1 in the real space S to understand association of the person 1 with an object in the real space and how the object is affected by movement of the person 1.

That is, the association image includes an arbitrary image that makes it possible for the person 1 to understand what the object associated with the person 1 himself/herself is and how the object is affected by his/her movement. The association image can be said to be an image from which the movement of the object with respect to his/her movement can be predicted.

The object associated with the person 1 includes, for example, an arbitrary object present in the real space S. For example, the object includes an arbitrary object such as an electronic apparatus and an object that is not an electronic apparatus.

Further, the object includes an arbitrary image displayed in the real space S. That is, in the real space S, various images are displayed as objects. Various images displayed as objects will be described below as the object image collectively in some cases.

In the example shown in FIG. 1, as an association image, a string-shaped image (hereinafter, referred to as a string image) 15 is displayed so as to connect the person 1 and an object to each other. The string image 15 can be referred to also as a virtual string.

A string image 15a is displayed so as to connect a person 1a and an object image 7a to each other.

A string image 15b is displayed so as to connect a person 1b and an object image 7b to each other.

A string image 15c is displayed so as to connect the person 1b and the lighting apparatus 3 to each other. As described above, a plurality of objects may be associated with one person 1. In this case, the string image 15 is displayed between the one person 1 and each object. That is, a plurality of string images 15 extends from one person in some cases.

Note that there may be a display form in which one string image 15 is branched from the middle and extends toward a plurality of objects.

A string image 15d is displayed so as to connect a person 1c and the electronic piano 4 to each other.

The string image 15 is displayed as, for example, an image imitating an actual string object having a defined length. For example, an image imitating an arbitrary string object such as a rope, a lead, and a thread can be adopted as an association image. Further, the thickness, the color, and the like may be arbitrarily set.

For example, the color and the like of the string image 15 are distinguished from each other for each person 1. As a result, it is possible to more easily understand the association between the person 1 and an object.

The display control unit 31 is capable of controlling the display mode of the string image 15 on the basis of the distance between the person 1 and the object associated with the person 1. For example, the tension expression of the string image 15 is controlled on the basis of the distance between the person 1 and the object.

For example, as the distance between the person 1 and the object increases, the string image 15 is displayed such that the string image 15 is tighter (more tension is applied). As the distance between the person 1 and the object decreases, the string image 15 is displayed such that the string image 15 is looser.

Note that the distance between the person 1 and the object can be calculated on the basis of position information of the person 1 and position information of the object.

The person 1a can understand the association between the person 1a himself/herself and the object image 7a by the string image 15a.

Further, the person 1a can understand how the object image 7a is affected by the movement of the person 1a himself/herself, by the display mode of the string image 15a, specifically, the shape of the string image 15a (tension expression).

For example, it can be seen that in the case where the string image 15a is in a loose state, even if the person 1a himself/herself moves, the object image 7a is not affected by the movement. Further, it is possible to understand, by the degree of looseness, the movement distance that does not affect the object image 7a.

It can be seen that in the case where the string image 15a is in a state of being linearly fully stretched, if the person 1a himself/herself moves, the object image 7a is directly affected by the movement. For example, it can be seen that if the person 1a goes straight in the direction in which the string image 15 extends, the object image 7a is tighter in the direction.

The person 1b can understand, by a string image 15b, the association between the person 1b himself/herself and the object image 7b. Further, the person 1b can understand, by the shape of the string image 15b (tension expression), how the object image 7b is affected by the movement of the person 1b himself/herself.

Further, the person 1b can understand, by the string image 15c, the association between the person 1b himself/herself and the lighting apparatus 3. Further, the person 1b can understand, by the shape of the string image 15c (tension expression), how the lighting apparatus 3 is affected by the movement of the person 1b himself/herself.

The person 1c can understand, by the string image 15d, the association between the person 1c himself/herself and the electronic piano 4. Further, the person 1c can understand, by the shape of the string image 15d (tension expression), how the electronic piano 4 is affected by the movement of the person 1c himself/herself.

Note that since the string image 15 is just an image, no physical force acts on the associated object. As described below, in this image display system 100, processing of changing the display position of the object image 7 depending on the movement of the person 1 or the like can be performed as one of processes for realizing new user experience. When executing such processing, by controlling the display of the virtual string image 15, it is possible to feed back the affection of the movement of the person 1 on the object image 7 to the person 1.

By making the string image 15 an image imitating an actual string object, it is possible for the person 1 to easily understand how an object is affected by the movement of the person 1 himself/herself even in the case where the person 1 has no special knowledge or the like.

For example, it is possible to intuitively understand the relationship regarding the movement with the object image 7, such as “I can freely move because the rope (the string image 15) is loose”, “When I move, the object image 7 also moves, because the rope (the string image 15) is fully stretched”, and “when I move, I can cause the object image 7 to move, because the rope (the string image 15) is fully stretched”. As a result, it is possible to realize new user experience with high quality.

For example, assumption is made that a moving mechanism, an actuator mechanism, and the like capable of causing an object (physical object) present in the real space S to move or fall down are provided. In this case, such control that an object moves or falls down on the basis of the movement of the person 1 connected to the object via the string image 15 is possible. As a result, it is possible to realize attractions and the like corresponding to the movement of the person 1 and realize new user experience.

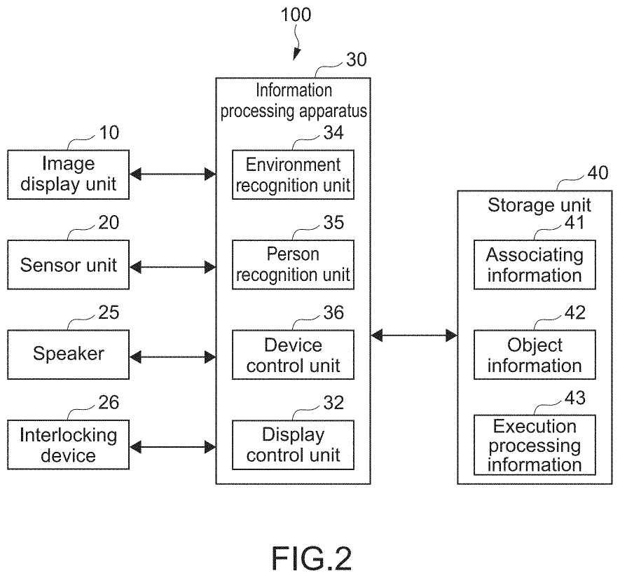

FIG. 2 is a block diagram showing a functional configuration example of the image display system 100 and the information processing apparatus 30.

In the example shown in FIG. 2, a speaker 25 is disposed in the real space S in addition to the image display unit 10 and the sensor unit 20.

By controlling the speaker 25, it is possible to notify the person 1 of various types of information via voice. Further, it is also possible to output, as content, voice such as voice of a content image. Further, it is also possible to output sound effects or the like.

An interlocking device 26 shown in FIG. 2 is an electronic apparatus or the like whose operation can be controlled by the information processing apparatus 30.

In the information processing apparatus 30 illustrated in FIG. 2, a processor such as a CPU executes a predetermined program, thereby configuring an environment recognition unit 34, a person recognition unit 35, a device control unit 36, and the display control unit 31 as functional blocks.

The environment recognition unit 34 generates the environment information described above.

The person recognition unit 35 generates the person information described above.

That is, the information processing apparatus 30 illustrated in FIG. 2 has a function of generating environment information and person information included in the space-related information 32. As described above, the algorithm and the like for generating environment information and person information are not limited.

The device control unit 36 controls the operation of the speaker 25 and the interlocking device 26. The method of controlling the operation of the speaker 25 and the interlocking device 26 is not limited, and an arbitrary method (algorithm or the like) may be adopted.

For example, the information processing apparatus 30 may be provided with software or the like (e.g., application program) for controlling the interlocking device 26 and the like.

For example, position information, apparatus information, and the like of the interlocking device 26 may be registered in advance, and the operation of the interlocking device 26 may be controllable by activating predetermined software.

Alternatively, in the case where an API (Application Programming Interface) of software for controlling the operation of the interlocking device 26 is open to the public, the operation of the interlocking device 26 and the like can be controlled by calling the API.

FIG. 2 illustrates a storage unit 40. The storage unit 40 may include a storage device such as an HDD provided in the information processing apparatus 30. Alternatively, the storage unit 40 may include an external storage device connected to the information processing apparatus 30. Even in the case where an external storage device is used, the external storage device can be regarded as part of the information processing apparatus 30.

In the example shown in FIG. 2, associating information 41, the object information 42 described above, and execution processing information 43 are stored in the storage unit 40. Although not shown, various types of other information necessary for the operation of this image display system 100 are stored.

The associating information 41 includes association between the person 1 and an object. In the example shown in FIG. 1, the association between the person 1a and the object image 7a, the association between the person 1b and the object image 7b, the association between the person 1b and the lighting apparatus 3, and the association between the person 1c and the electronic piano 4 are stored.

The execution processing information 43 includes information regarding processing executed in response to an operation or the like using the string image 15 by the person 1 described below.

The data format, the storage format, and the like of information to be stored in the storage unit 40 are not limited. For example, a key-value type database or a document-type database may be constructed to store each piece of information.

In the example shown in FIG. 2, a display control unit according to the present technology is realized by the display control unit 31.

A determination unit that determines an instruction from a person in the real space S is realized by the person recognition unit 35.

A processing execution unit that executes processing regarding an object associated with the person 1 is realized by cooperation of the device control unit 36 and the display control unit 31.

[Operation of Image Display System]

An operation example of the image display system 100 will be described.

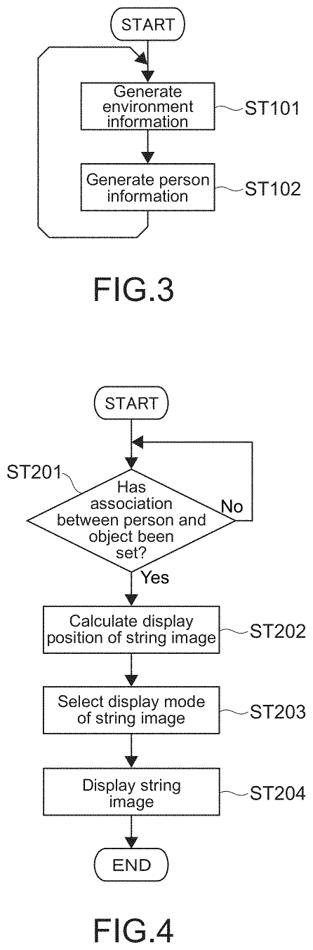

FIG. 3 is a flowchart showing an operation example of the information processing apparatus 30.

As shown in FIG. 3, generation of environment information by the environment recognition unit 34 and generation of person information by the person recognition unit 35 are repeatedly executed at predetermined intervals on the basis of the detection result of the sensor unit 20 (Step 101, Step 102).

That is, in this embodiment, environment recognition and person recognition are repeatedly executed on the real space S. The generated environment information and person information are output to the device control unit 36 and the display control unit 31.

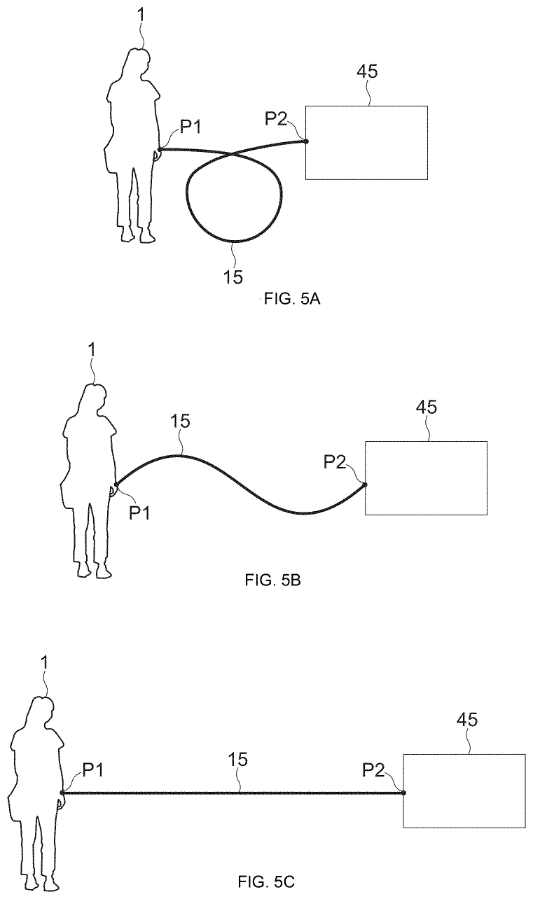

FIG. 4 is a flowchart showing a processing example when newly displaying the string image 15. FIG. 5 is a schematic diagram showing a display example of the string image 15.

The display control unit 31 monitors whether or not association between the person 1 and an object 45 in the real space S has been set (Step 201).

In the case where association between the person 1 and the object has been set (Yes in Step 201), the display control unit 31 calculates the display position of the string image 15 (Step 202).

As shown in Parts A to C of FIG. 5, for example, a first endpoint P1 of the string image 15 on the side of the person 1 and a second endpoint P2 of the string image 15 on the side of the object 45 are calculated on the basis of the position of the person 1 and the position information of the object 45.

For example, one point on the periphery of the person 1 is calculated as the first endpoint P1, and one point on the periphery of the object 45 is calculated as the second endpoint P2. The method of calculating the first endpoint P1 and the second endpoint P2 is not limited, and a predetermined position capable of displaying the string image 15 only needs to be calculated.

The display control unit 31 selects the display mode of the string image 15 (Step 203). For example, a display mode is selected on the basis of the distance between the person 1 and the object 45. The display mode of the string image 15 may be selected on the basis of the distance between the first endpoint P1 and the second endpoint P2 shown in Parts A to C of FIG. 5.

The display mode is typically the shape of the string image 15 (tension expression). That is, a shape capable of expressing how tight the string image 15 is (how much tension is applied) or how loose the string image 15 is is appropriately selected.

For example, as shown in Part A of FIG. 5, in the case where the distance between the person 1 and the object 45 is small, a display mode in which the string image 15 is sufficiently loose is selected. As shown in Part B of FIG. 5, in the case where the distance between the person 1 and the object 45 increases, a display mode in which the string image 15 is tightened and the looseness is reduced is selected. As shown in Part C of FIG. 5, in the case where the distance between the person 1 and the object 45 is large, a display mode in which the string image 15 is fully stretched is selected.

For example, a plurality of display modes capable of expressing the tension of the string image 15 is stored. Then, one display mode of the plurality of display modes is selected on the basis of the distance between the person 1 and the object 45. A threshold value or the like for selecting a display mode may be set in a stepwise manner regarding the distance between the person 1 and the object 45.

For example, in the case where the distance between the person 1 and the object 45 equals to the maximum threshold value, a fully stretched display mode as illustrated in Part C of FIG. 5 is selected.

The display control unit 31 displays the string image 15 (Step 204). In the example shown in FIG. 5, the string image 15 of a display mode selected in Step 203 is displayed so as to connect the first endpoint P1 and the second endpoint P2 to each other.

For example, the string image 15 is displayed so as to crawl on the wall surface 5, the floor, or the like. The present technology is not limited thereto, and a laser beam, a hologram image, and the like may be used to three-dimensionally display the string image 15.

The method of displaying the string image 15 in accordance with new association is not limited, and another arbitrary method may be adopted.

For example, the display position of the entire string image 15 may be set on the basis of the distance between the person 1 and the object 45. That is, the display position of the entire string image 15 considering the tension expression may be calculated. Then, the entire string image 15 may be displayed at the calculated display position.

Further, how to change the display mode (tension expression) in accordance with the distance between the person 1 and the object 45 is also not limited. For example, only three stages of change such as a first stretched state (that can be referred to also as a loose state), a second stretched state, and a third state as illustrated in FIG. 5 may be used.

Meanwhile, highly-reproducible (highly-realistic) display control according to the distance between the person 1 and the object 45 such as stretching an actual string object little by little may be executed. As a result, it is possible to realize user experience with high quality.

In Step 201 in FIG. 4, an example in which new association is set will be described. The new association can be referred to also as a trigger for display of a new string image 15.

For example, the person 1 designates an object to be associated. The designation of an object can be executed by an arbitrary instruction method via a gesture or voice.

For example, it is possible to designate an object by saying “I want to be associated with (an object)” while pointing to the object. It goes without saying that an instruction to designate an object may be inputtable by only a gesture pointing to the object. Further, an instruction to designate an object may be inputtable by only saying “I want to be associated with a television set”. In addition, an arbitrary method may be adopted.

Note that the direction pointed by the person 1, the direction in which the person 1 extends his/her arm, and the like can be calculated on the basis of movement information of the person. Further, an object present in the pointing direction can be recognized on the basis of environment information.

The display control unit 31 sets, on the basis of an instruction to designate an object to be associated, the association between the person 1 and the object. Accordingly, the processing proceeds to Step 202, and the string image 15 is displayed. Further, the associating information 41 in the storage unit 40 is updated.

In the case where the person 1 has input some instruction regarding an object in the real space S, the person 1 and the object to be instructed may be associated with each other.

For example, assumption is made that the person 1 has input an instruction to change the content of a content image(the object image 7) displayed on the wall surface 5. In this case, the person 1 and the content image to be instructed are associated with each other. Further, in the case where the person 1 has input an instruction to turn on the lighting apparatus 3, the person 1 and the lighting apparatus 3 are associated with each other. In the case where an instruction different from an instruction indicating to desire association has been input for an object as described above, association may be set using that as a trigger and the string image 15 may be displayed.

Assumption is made that an instruction to display the object image 7 has been input from the person 1 by an utterance, a gesture, or the like. In this case, the object image 7 may be displayed and the object image 7 and the person 1 may be associated with each other. Note that the display position of the object image 7 may be designated.

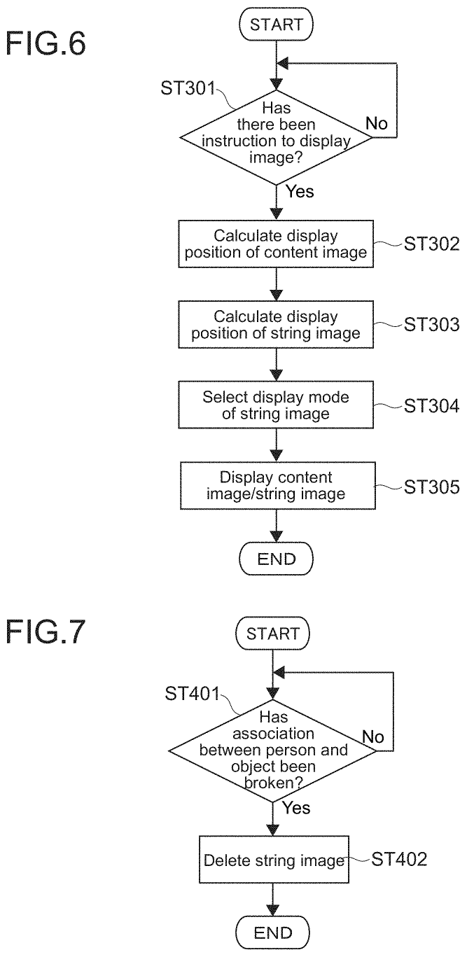

FIG. 6 is a flowchart showing a processing example of association according to an instruction to display a content image.

For example, the person 1 makes a gesture of extending his/her arm toward the wall surface 5. Assumption is made that this gesture is stored as an instruction to display a content image accompanied by a designation of the display position.

The display control unit 31 determines in Step 301 that there has been an instruction to display a content image, and calculates the display position of the content image in Step 302. For example, the wall surface 5 present in the direction in which the person 1 extends his/her arm is detected. Then, the display position of the content image is calculated with reference to the intersection between the direction (vector) in which the arm is extended and the wall surface 5.

In Step 303, the display position of the string image 15 is calculated. In Step 304, the display mode of the string image 15 is selected on the basis of the distance between the person 1 and the display position of the content image. In Step 305, a content image and the string image 15 are displayed.

In Step 305, geometric transformation may be performed on the content image on the basis of the person 1 and the display position of the content image on the wall surface 5. Specifically, the image is geometrically transformed such that the content image is displayed faces the person 1. As a result, it is possible to provide user experience with high quality. The algorithm or the like for geometrically transforming an image is not limited.

Note that in the case where the display position is not designated, for example, the object image 7 only needs to be displayed at the default position or the like.

Note that a designation of the display position and an instruction to display the object image 7 can be input by other posture, the line of sight, the orientation of the face, or the like instead of the gesture of extending his/her arm.

As described above, association can be set and the string image 15 can be displayed in accordance with the input of various instructions via an utterance, a gesture, or the like.

The present technology is not limited thereto, and the setting of association and display of the string image 15 may be executed on the basis of the movement of the person 1.

For example, the string image 15 that associates the person 1 and an object with each other may be displayed on the basis of the movement of the person 1 to extends his/her arm toward the object. Further, the object image 7 is displayed on the wall surface 5 and the person 1 and the object image 7 are associated with each other on the basis of the movement of the person 1 to point to the wall surface 5. As described above, the association may be executed in accordance with only the movement without determining the input instruction.

That is, in this image display system 100, it is possible to execute the display control of the string image 15 based on an instruction from the person 1 and display control of the string image 15 based on the movement information of the person 1 in an appropriate combination. It goes without saying that an embodiment in which only one of the display control based on an instruction and the display control based on the movement can be executed can be realized.

Note that in the case where an instruction or the like by an utterance has been input and the person 1 who has made the utterance cannot be identified, a notification to request for re-inputting an instruction is output via the speaker 25 or the like.

FIG. 7 is a flowchart showing a processing example when deleting the string image 15.

For example, in the case where the association between the person 1 and the object is broken, the string image 15 is deleted (Steps 401 and 402).

For example, in the case where an instruction to break the association has been input from the person 1, the association is broken. The method of inputting the instruction to break the association is not limited, and an arbitrary method using an utterance, a gesture, or the like may be used.

Alternatively, the association may be broken in the case where predetermined movement is performed.

For example, the association is broken in the case where the person 1 makes a gesture of cutting the string image 15. Alternatively, the association may be broken on the basis of the utterance such as “Cut this string!”.

[Processing after Displaying String Image 15]

In this image display system 100, it is possible to realize various types of user experience making the best use of the features of the string image 15.

For example, in the example shown in FIG. 1, assumption is made that the object image 7a associated with the person 1a is a content image such as a movie and a television program. Assumption is made that also the object image 7b associated with the person 1b is a content image. The electronic piano 4 is associated with the person 1c.

Now, assumption is made that the person 1 who is one of the persons 1a to 1c has input an instruction to increase the volume via an utterance.

The person recognition unit 35 identifies the person 1 who has made the utterance and determines the content of the instruction.

In the case where the person who has made the utterance is the person 1a, the speaker 25 is controlled such that the volume regarding the object image 7a that is a content image increases.

In the case where the person who has made the utterance is the person 1b, the speaker 25 is controlled such that the volume regarding the object image 7b that is a content image increases.

Assumption is made that the person who has made the utterance is the person 1c. In this case, in the case where the electronic piano 4 is the interlocking device 26, the volume of the electronic piano 4 increases. In the case where the electronic piano 4 is not a device that can be interlocked, for example, the state is maintained without doing anything. Alternatively, notification of an image, voice, or the like of error display may be made.

As described above, on the basis of an instruction from the person 1 in the real space S, processing regarding the object associated with the person 1 who has input the instruction is executed. The display control unit 31 and the device control unit 36 execute an executable command on the basis of the association regarding the person 1 who has input the instruction.

For example, even in the case where an operation that does not explicitly indicate the operation target (an ambiguous instruction), such as “Turn up the volume”, is performed by voice input or the like, the operation can be executed because the relationship with the operation target is known by the string image 15. Further, it is possible to take a different measure for each person 1.

[Follow-Up Movement of Object Image]

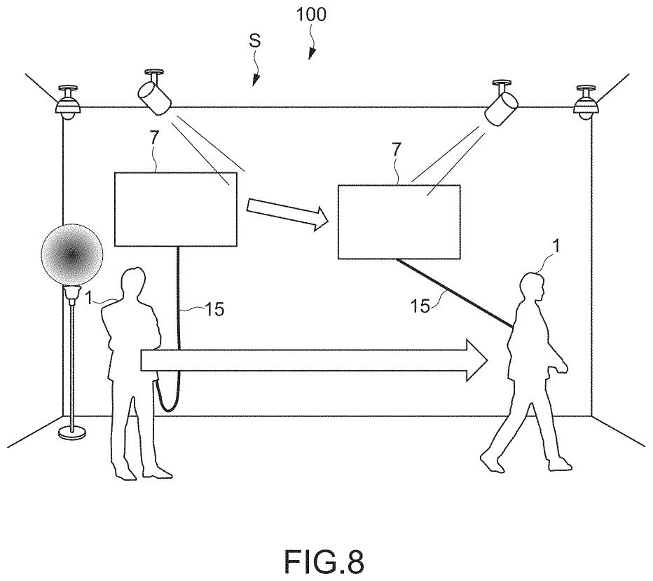

FIG. 8 is a schematic diagram for describing follow-up of the object image 7.

As shown in FIG. 8, the display control unit 31 is capable of causing, in the case where the person 1 has moved in a direction away from the object image 7 while the string image 15 connecting the person 1 and the object image 7 to each other is fully stretched, the object image 7 to move so as to follow the movement of the person 1.

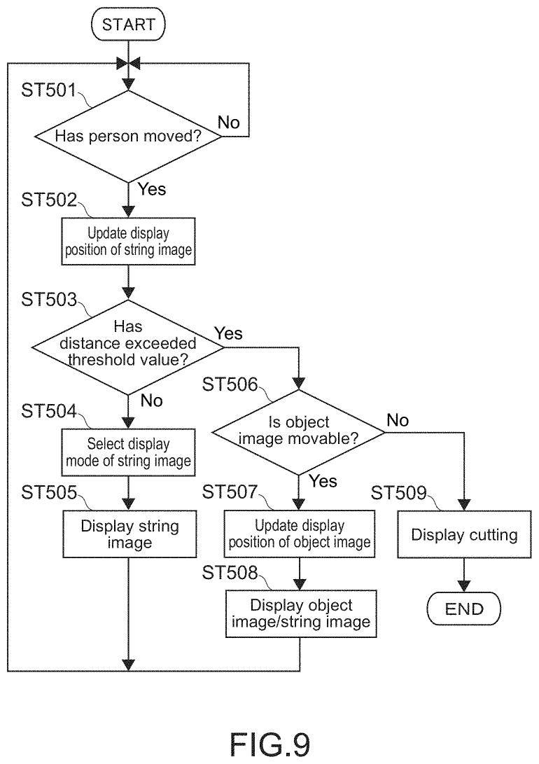

FIG. 9 is a flowchart showing a specific processing example of follow-up control of the object image 7. The processing shown in FIG. 9 is executed in the case where the object image 7 is associated as an object.

Whether or not the person 1 has moved is monitored (Step 501).

In the case where the person 1 has moved (Yes in Step 501), the display position of the string image 15 is updated (Step 502). For example, the first endpoint P1 and the second endpoint P2 illustrated in FIG. 5 are updated.

Whether or not the distance between the person 1 and the object image 7 has exceeded a threshold value is determined (Step 503). For example, the distance between the first endpoint P1 and the second endpoint P2 may be a determination target. Further, the threshold value may be arbitrarily set. The threshold value may be settable by the person 1.

In the case where the distance between the person 1 and the object image 7 does not exceed the threshold value (No in Step 503), the display mode of the string image 15 is selected on the basis of the distance between the person 1 and the object image 7, and the string image 15 is displayed (Steps 504 and 505).

In the case where the distance between the person 1 and the object image 7 has exceeded the threshold value (Yes in Step 503), whether or not the object image 7 is movable is determined (Step 506).

Typically, the object image 7 is set to be movable. Meanwhile, the person 1 can restrict the movement of the object image 7. In such a case, the object image 7 cannot move.

In the case where the object image 7 is movable (Yes in Step 506), the display position of the object image 7 is updated, and the object image 7 and the string image 15 are displayed (Steps 507 and 508). Note that as the display mode of the string image 15, the fully stretched state is maintained.

Regarding the calculation of the display position of the object image 7, the trajectory in which the object image 7 moves may be calculated on the basis of the movement of the person 1 and the display position of the string image 15, and the display position of the object image 7 may be updated on the basis of the trajectory. For example, the trajectory of the object image 7 may be calculated by mimicking the kinetic model of an object such as a ball.

In the case where the object image 7 is not movable (No in Step 506), the display of the string image 15 is controlled such that the string image 15 is cut (Step 509). The present technology is not limited thereto, and notification that the object image 7 cannot follow may be executed. Alternatively, a warning or the like that the string image 15 is cut off and the association is broken when moving as it is may be executed. In addition, display control of stretching the string image 15 may be executed.

For example, assumption is made that the object image 7 is caused to follow the movement of the person 1 without displaying the string image 15. In this case, it is likely that it will be difficult for the person 1 to understand why the object image 7 makes such movement.

In this image display system 100, the follow-up operation of the object image 7 is controlled using the display mode of the string image 15 (tension expression). As a result, the person 1 can intuitively understand the movement of the object image 7. That is, the person 1 can understand the intention on the side of the system and perform an operation as appropriate.

Note that as control of the follow-up operation using tension expression of the string image 15, various variations can be considered. For example, it is also possible to perform such display control that the follow-up of the object image 7 starts immediately before entering the fully stretched state and the follow-up speed gradually increases. The degree of follow-up of the object image 7 with respect to the person 1 may be appropriately controlled in accordance with the tension expression of the string image 15.

Further, in the case where the person has stopped, also the object image 7 follows and stops at the same timing. The present technology is not limited thereto, and it is also possible to perform such display control that the object image 7 moves slightly inertially and then stops.

In the example shown in FIG. 1, the object image 7a is associated with the person 1a and the string image 15a is displayed. Further, the object image 7b is associated with the person 1b and the string image 15b is displayed.

The follow-up control of the object image 7 is executed on the basis of the movement of the person 1 associated with the object image 7. That is, the display of the object image 7a is controlled so as to follow only the person 1a. The display of the object image 7b is controlled so as to follow only the person 1b.

Note that in the case where a plurality of object images 7 is associated with one person 1, the plurality of object images 7 is capable of following the movement of the person 1 and moving. It goes without saying that such display control that the object image 7 moves in the order of the string image 15 being fully stretched can be performed.

Note that the object image 7 moves depending on the content of the application in some cases. For example, a case where a virtual object image or the like of a balloon is displayed as the object image 7, and is associated with the person 1 can be considered.

In such a case, whether or not the distance between the object image 7 and the person 1 exceeds a threshold value is determined in accordance with the movement of the object image 7. In the case where the distance between the object image 7 and the person 1 does not exceed the threshold value, the display mode of the string image 15 is appropriately selected on the basis of the distance between the object image 7 and the person 1, and the object image 7 and the string image 15 are displayed.

In the case where the distance between the object image 7 and the person 1 exceeds the threshold value, the movement of the object image 7 is restricted while the string image 15 is fully stretched. That is, the display position of the object image 7 is fixed. The present technology is not limited thereto, and such display control that it floats fluffy like an actual balloon may be executed.

Assumption is made that the person 1 has moved while an object and the person 1 present in the real space S are associated with each other. In this case, in the case where the distance between the person 1 and the object does not exceed a threshold value, the display mode of the string image 15 is appropriately selected and displayed on the basis of the distance between the person 1 and the object. In the case where the distance between the person 1 and the object has exceeded the threshold value, for example, such cutting display that the string image 15 is cut is executed as in Step 509 in FIG. 9. It goes without saying that the present technology is not limited thereto, and a warning or the like may be executed.

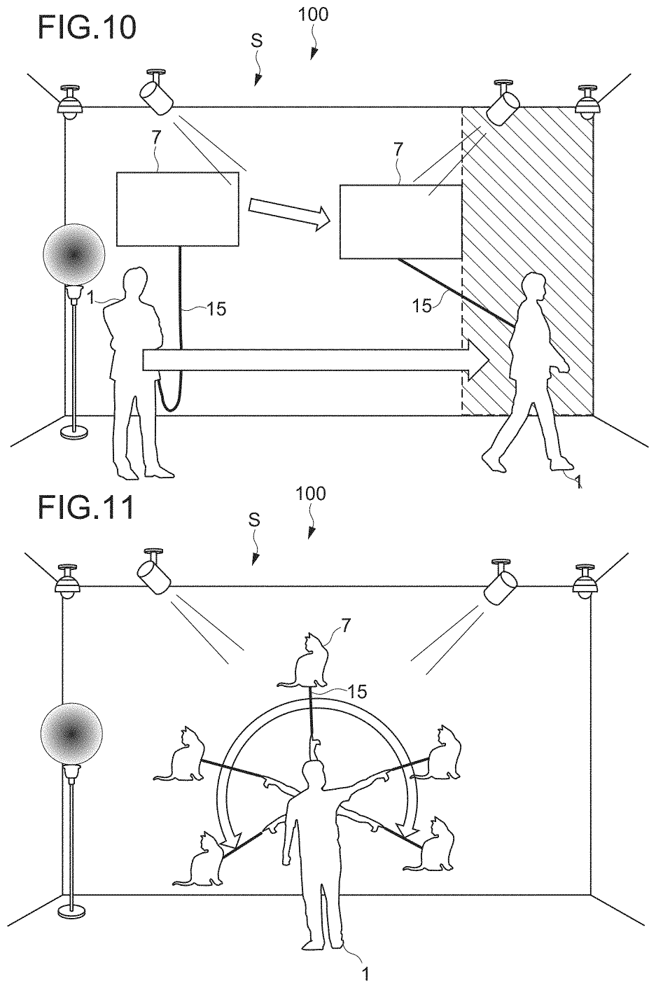

As illustrated in FIG. 10, a display restriction area 47 in which display of an image is restricted may be set in the real space S. For example, a non-displayable area in which an image cannot be displayed by the image display unit 10 or a display prohibited area in which display of an image is prohibited is set as the display restriction area 47.

For example, the display restriction area 47 may be settable by the person 1.

Information of the display restriction area 47 in the real space S is information included in the space-related information.

As illustrated in FIG. 10, assumption is made that the object image 7 moves so as to follow the movement of the person 1. For example, the display control unit 31 fixes the object image 7 that moves toward the display restriction area 47 at the position immediately before the display restriction area 47. The object image 7 cannot move anymore, and it is determined in Step 506 that the object image 7 cannot move in the flow illustrated in FIG. 9, for example.

The present technology is not limited to the case where the display position of the object image 7 is fixed, and such display control that the object image 7 bounces off may be executed.

[Operation of String Image 15]

In this image display system 100, the person 1 can operate the string image 15 to execute various types of processing.

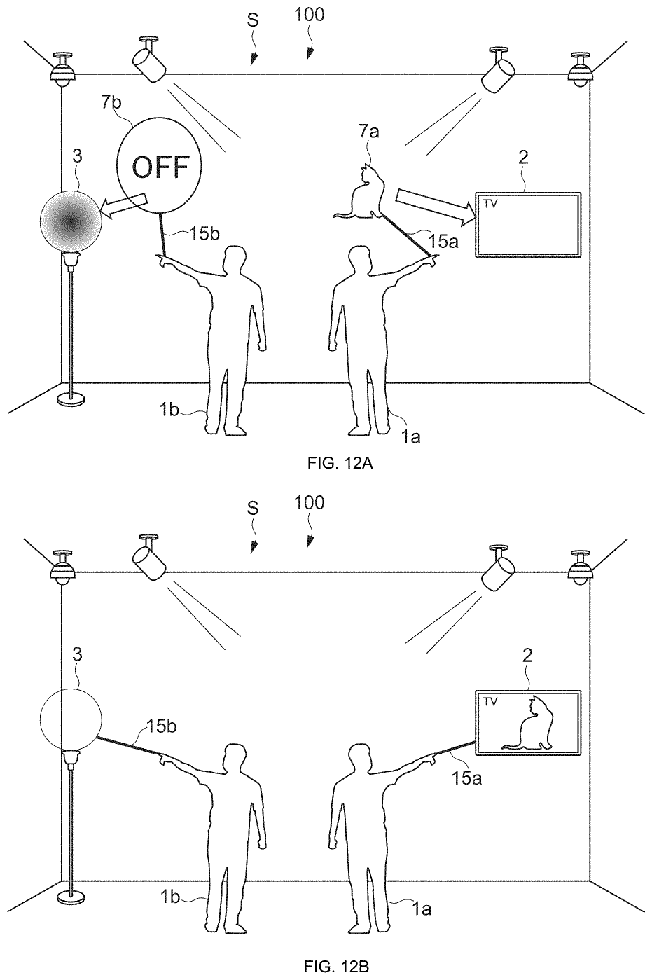

For example, as illustrated in FIG. 11, assumption is made that as the object image 7, a virtual object image in which a cat is virtually displayed is associated with the person 1.

The person 1 can operates the string image 15 to cause the object image 7 to move.

For example, the person recognition unit 35 recognizes the movement of the person 1 operating the string image 15. The display control unit 31 is capable of causing the object image 7 to move on the basis of the movement of the person 1 operating the string image 15.

For example, the final position (position after movement) of the object image 7 and the trajectory of the movement of the object image 7 are calculated on the basis of the direction in which the arm of the person 1 extends, the direction of arm swing, the speed of arm swing, the acceleration of arm swing, and the like.

The display position of the string image 15 is calculated on the basis of the final position of the object image 7 and the position of the person 1, and a display mode is selected. As a display mode, typically, a fully stretched state is selected.

The object image 7 is displayed at the final position, and the string image 15 is displayed between the object image 7 and the person 1. Note that an image that expresses the trajectory of the movement of the object image 7 may be displayed.

As the operation of the string image 15, various operations that can be performed on an actual string object such as pulling, pinching, winding up, cutting, connecting, transplanting, stretching, shrinking, splitting (separating), and tapping can be considered. Processing may be appropriately associated and executed in accordance with each operation. The associated processing is stored as, for example, the execution processing information 43.

Further, it is also possible to make the string image 15 thicker, thinner, softer, and hardened. As a result, it is also possible to change the characteristics (parameter) regarding follow-up to the person 1.

Further, assumption is made that the string image 15 is displayed such that the string image 15 is connected around the ankle of the person 1. In this case, it is possible to operate the string image 15 by raising up the leg to which the string image 15 is connected.

The present technology is not limited thereto, and the string image 15 may be operable by shaking the arm although the string image 15 is connected to the leg. That is, the position at which the string image 15 is connected (position at which the string image 15 is displayed) and the operation of the string image 15 may be associated with each other or do not necessarily need to be associated with each other.

For example, it is also possible to perform such control that the string image 15 can be operated by shaking the arm after performing an operation of picking up the string image 15 connected to the leg. As a result, highly-realistic display control is realized.

[Operation from Object Image 7 to Physical Object]

The operation of causing the object image 7 to move and superimposing it on a physical object will be described. The operation of superimposing the object image 7 on a physical object can be referred to as an operation of causing the object image 7 to collide with a physical object.

FIG. 12 is a schematic diagram describing a control example of the interlocking device 26 by operating the string image 15.

In this image display system 100, the person 1 can operate the string image 15 to superimpose the object image 7 on an electronic apparatus in the real space S, thereby executing various types of processing. That is, in this image display system 100, it is possible to control the electronic apparatus on the basis of the movement of the person 1 operating the string image 15 to superimpose the object image 7 on the electronic apparatus.

In the example shown in Part A of FIG. 12, as the object image 7, a virtual object image in which a cat is virtually displayed is associated with the person 1a. Further, as the object image 7b, an apparatus control image indicating to turn off the power source of the electronic apparatus is associated with the person 1b.

As illustrated in Part B of FIG. 12, the person 1a operates the string image 15a to cause the object image 7a to move and superimpose it on the television set 2. In response to this, the device control unit 36 causes the television set 2 to display content. The display control unit 31 deletes the object image 7a and displays the string image 15a between the person 1a and the television set 2. That is, setting of the association is changed.

As described above, it is possible to display, on the basis of the movement of superimposing the object image 7a on a display device such as the television set 2, an image regarding the object image 7a on the display device.

For example, the same image as the image displayed as the object image 7a may be displayed on the television set 2. For example, in the case where a content image such as a movie is displayed as the object image 7b, the same content image may be displayed on the television set 2.

The present technology is not limited thereto, and another image to which some attributes or the like relate is displayed. For example, as shown in Part B of FIG. 1, in the case where a virtual object image of a cat is superimposed on the television set 2, another image relating to a cat (e.g., a content image) may be displayed. In addition, various images may be displayed.

The person 1b operates the string image 15b to cause the object image 7b to move and superimpose it on the lighting apparatus 3. In response to this, the device control unit 36 turns off the power source of the lighting apparatus 3 to turn off the light. The display control unit 31 deletes the object image 7b and displays the string image 15b between the person 1b and the lighting apparatus 3. That is, setting of the association is changed.

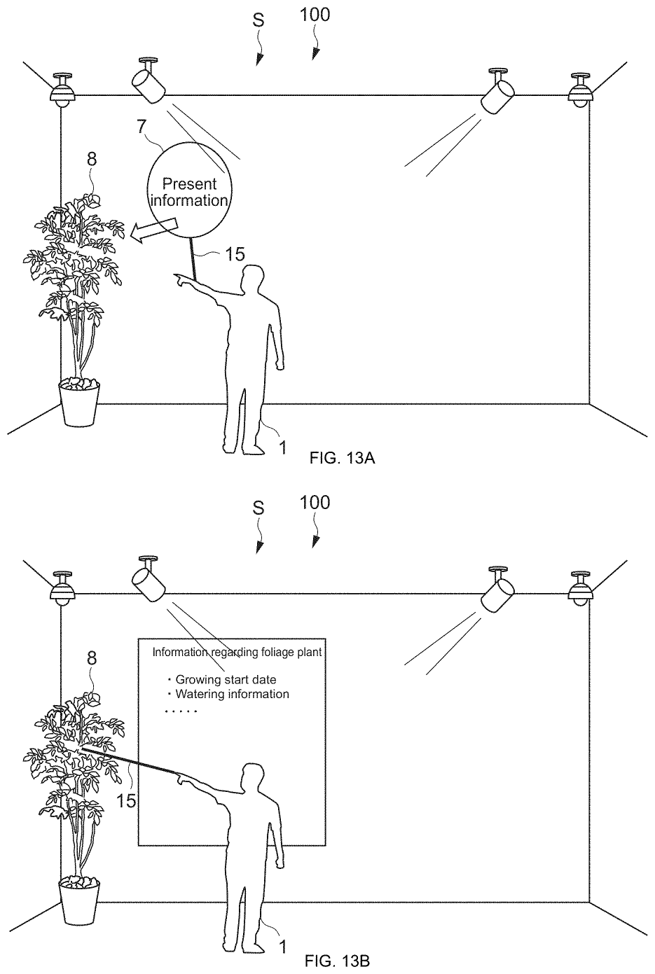

FIG. 13 is a schematic diagram describing an example of the operation of an object that is not an electronic apparatus of the string image 15.

In the example shown in Part A of FIG. 13, as the object image 7, a control image displaying to present information is associated with the person 1.

As shown in Part B of FIG. 13, the person 1 operates the string image 15 to cause the object image 7 to move and superimpose it on a foliage plant 8. In response to this, the display control unit 31 deletes the object image 7b and displays information regarding the foliage plant 8. Further, a string image is displayed between the person 1 and the foliage plant 8. That is, setting of the association is changed.

The information regarding the foliage plant 8 is displayed at, for example, a position close to the foliage plant 8. The present technology is not limited thereto. In the case where virtual expression such as AR (Augmented Reality) and MR (Mixed Reality) is possible, it may be displayed so as to be superimposed on the foliage plant 8.

Note that the information regarding the foliage plant 8 is stored as, for example, object information in the storage unit 40.

Assumption is made that the person 1 has instructed to associate with the foliage plant 8 while the person 1 and the foliage plant 8 are not associated with each other. Alternatively, assumption is made that the person 1 has made a movement of extending his/her arm toward the foliage plant 8. In response to such an instruction or movement, the person 1 and the foliage plant 8 are associated with other and the string image 15 is displayed. At that time, similarly to the case shown in Part B of FIG. 13, the information regarding the foliage plant 8 may also be displayed.

In any case, in this image display system 100, it is possible to display, in the real space S, object information regarding the object associated with the person 1.

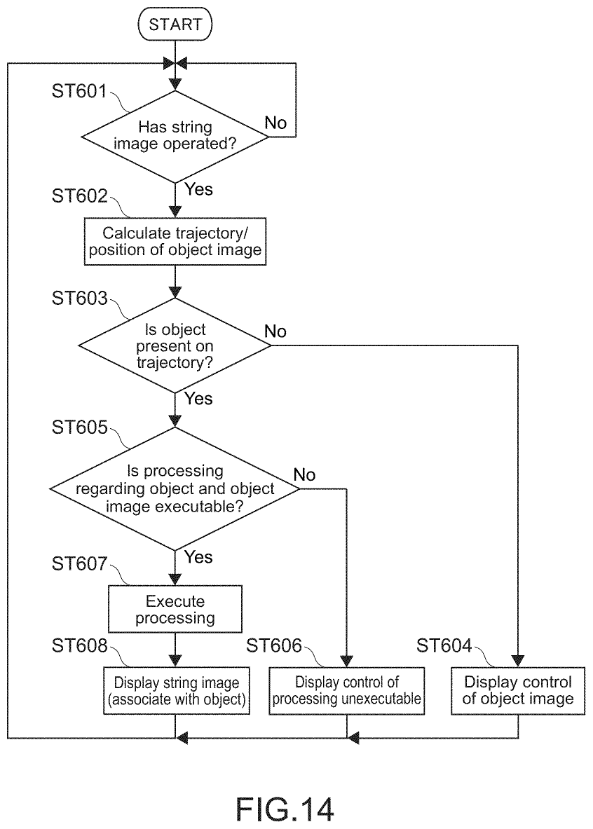

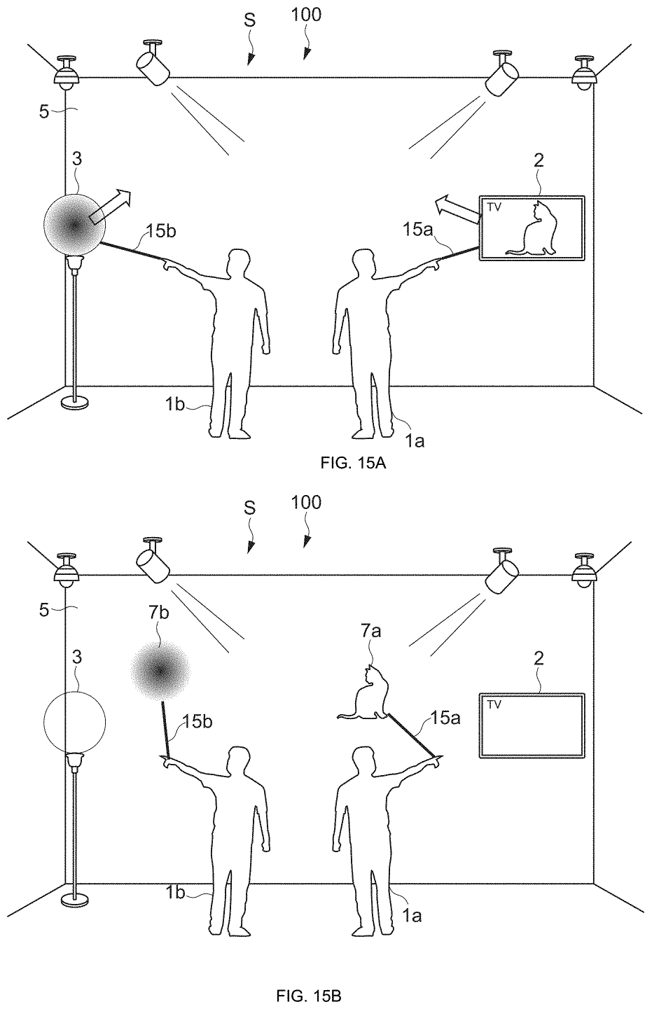

FIG. 14 is a flowchart showing a processing example corresponding to an operation from the object image 7 to a physical object. The processing shown in FIG. 14 is executed in the case where the object image 7 is associated.

Whether or not the string image 15 has been operated is monitored (Step 601).

In the case where the string image 15 has been operated (Yes in Step 601), for example, the final position (position after movement) of the object image 7 or the trajectory of the movement of the object image 7 is calculated on the basis of the direction in which the arm of the person 1 extends, the acceleration of arm swing, and the like (Step 602).

Whether or not an object is present on the calculated trajectory is determined (Step 603). In the case where no object is present on the trajectory (No in Step 603), the display control of the object image 7 is executed (Step 604). For example, the movement of the object image 7 such as that illustrated in FIG. 11 is executed.

In the case where no object is present on the trajectory (Yes in Step 603), whether or not processing regarding an object and the object image 7 can be executed is determined (Step 605). For example, whether or not there is executable processing is determined by referring to the execution processing information 43 stored in the storage unit 40.

In the case where processing regarding the object image 7 and the object superimposed on each other is not executable (No in Step 605), display control of processing unexecutable is executed (Step 606).

For example, such display control that the object image 7 collides with an object and bounces off is executed. Alternatively, such display control that the object image 7 passes through an object may be executed. The display control of passing through can be the same display control as the display control in Step 604. In addition, a notification indicating processing is impossible may be made via voice or an image.

In the case where the processing regarding the object image 7 and the object can be executed (Yes in Step 605), the processing is executed (Step 607). For example, image display by the television set 2, turning off of the lighting apparatus 3, or display of information regarding the foliage plant 8 illustrated in FIG. 12 and FIG. 13 is executed.

The string image 15 is displayed between the person 1 and the object on which the object image 7 is superimposed (Step 608).

The processing that can be executed by superimposing the object image 7 on an object is not limited, and various types of processing may be executable. As a result, it is possible to provide new user experience with high quality in various variations. Examples of variations are listed below.

It is possible to control an electronic apparatus by superimposing the object image 7 regarding control or status of the electronic apparatus on the electronic apparatus.

It is possible to display, on a display device, an image regarding the object image 7 by superimposing the object image 7 such as a content image on the display device.

A Web page displaying a cooking recipe is displayed as an information presentation image on the wall surface 5. By superimposing the information presentation image on a foodstuff, it is possible to display the recipe using the foodstuff.

Note that the display of the recipe may be executed together with the setting of association (display of the string image 15) in accordance with an instruction to associate with a foodstuff by the person 1 or the movement of extending the arm toward a foodstuff.

An icon of a camera is displayed as the object image 7. By superimposing the icon of a camera on an object in the real space S, it is possible to image the object. The imaging is executed by, for example, a camera included in the sensor unit 20.

Imaging conditions such as the imaging direction and the zoom magnification may be settable in accordance with the trajectory when superimposing the icon of a camera on an object. For example, by superimposing the icon of a camera from the lower side of the foliage plant 8, an image when the foliage plant 8 is viewed from below is taken. Such processing is also possible.

The SNS (Social Networking Service) site is displayed as the object image 7. By superimposing the object image 7 of SNS on an object in the real space S, it is possible to post a captured image of the object to the SNS.

By superimposing the object image 7 such as a sphere of light on a predetermined object such as a plate, an animation is developed around the predetermined object.

As the processing that can be executed in accordance with the operation of superimposing the object image 7, original processing for each person 1 may be registerable. Information regarding the registered processing is stored as the execution processing information 43.

Such control that assists to understand an object for which some processing can be executed by superimposing the object image 7 associated with the person 1 on the person 1 may be performed.

For example, assumption is made that the object image 7 regarding control of an electronic apparatus is associated. In this case, the object image 7 smoothly moves toward the electronic apparatus that can be controlled by superimposing the object image 7 thereon. Meanwhile, such control that the object image 7 cannot smoothly move and is difficult to move toward an electronic apparatus that cannot be controlled is also possible.

Further, an object for which some processing can be executed by superimposing the object image 7 thereon is illuminated, thereby making it easier for the person 1 to recognize it. Such processing is also possible.

Further, sound effects, guide voice, or the like may be appropriately used. Further, by changing the color, shape, or size of the object image 7 itself, information may be presented to the person 1. Further, text may be displayed.

[Operation from Physical Object to Real Space S]

In this image display system 100, the person 1 can execute various types of processing by operating the string image 15 connected to a physical object.

FIG. 15 is a schematic diagram describing an operation of the string image 15 to which an electronic apparatus is connected.

In the example shown in Part A of FIG. 15, the television set 2 displaying content (cat) is associated with the person 1a. Further, the lighting apparatus 3 in the lit state is associated with the person 1b.

As illustrated in Part B of FIG. 15, the person 1a operates the string image 15a to cause a tip of the string image 15a connected to the television set 2 to move from the television set 2 to another position. In response to this, the device control unit 36 turns off the display of content. The display control unit 31 displays, in the real space S, an image regarding the television set 2 as an object associated with the person 1a.

In the example shown in Part B of FIG. 15, a content image, a virtual object image, or the like regarding the content (cat) displayed on the television set 2 is displayed as the object image 7a on the wall surface 5. Then, the string image 15a connecting the person 1a and the object image 7a to each other is displayed. As an image regarding the television set 2, an arbitrary image may be displayed.

The person 1b operates the string image 15b to cause the tip of the string image 15b connected to the lighting apparatus 3 to move from the lighting apparatus 3 to another position. In response to this, the device control unit 36 turns off the lighting apparatus 3. The display control unit 31 displays, in the real space S, an image regarding the lighting apparatus 3 as an object associated with the person 1b.

In the example shown in Part B of FIG. 15, an image of light imitating the lit state of the lighting apparatus 3 is displayed as the object image 7b. Then, the string image 15b connecting the person 1b and the object image 7b to each other is displayed. As an image regarding the lighting apparatus 3, an arbitrary image may be displayed.

As described above, the display control unit 31 is capable of displaying, in the real space S, an image regarding an electronic apparatus as an object associated with the person 1, on the basis of the movement of the person 1 causing the tip of the string image 15 displayed so as to connect the person 1 and the electronic apparatus to each other to move from the electronic apparatus to another position.

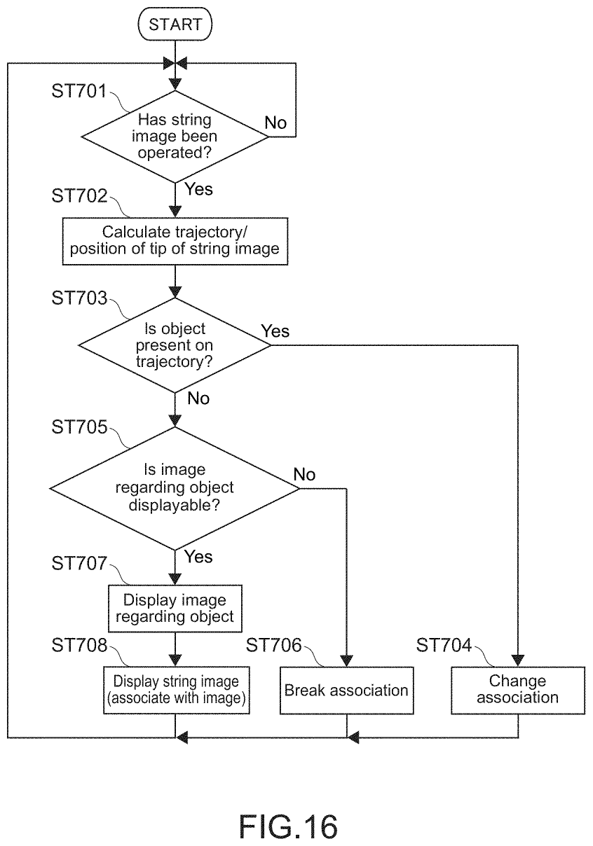

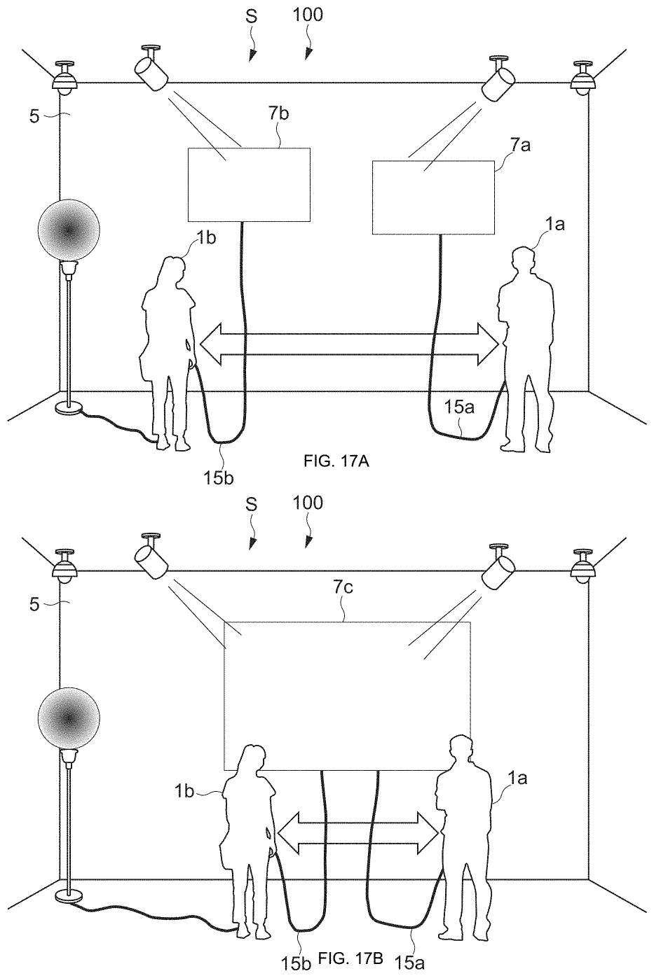

FIG. 16 is a flowchart showing a processing example corresponding to the operation the string image 15 to which an object is connected. The processing shown in FIG. 16 is executed in the case where an object is associated.

Whether or not the string image 15 has been operated is monitored (Step 701).

In the case where the string image 15 has been operated (Yes in Step 701), for example, the final position (position after movement) of the tip of the string image 15 and the trajectory of the movement of the tip are calculated on the basis of the direction in which the arm of the person 1 extends, the acceleration of arm swing, and the like (Step 702).

Whether or not an object is present on the calculated trajectory is determined (Step 703). In the case where an object is present on the trajectory (Yes in Step 703), for example, the association is changed (Step 704). The person 1 and the object present on the trajectory are associated with each other, and the string image 15 is displayed.

In the case where no object is present on the trajectory (Yes in Step 703), whether or not an image regarding an object can be displayed is determined (Step 705). For example, whether or not there is an image that can be displayed is determined by referring to the execution processing information 43 stored in the storage unit 40.

In the case where an image regarding an object cannot be displayed (No in Step 705), for example, the association is broken (Step 706). The display control unit 31 deletes the string image 15. Notification that the association has been broken may be made via voice or an image.

In the case where an image regarding an object can be displayed (Yes in Step 705), an image regarding an object is displayed (Step 707). For example, the object images 7a and 7b illustrated in FIG. 15 are displayed. The string image 15 is displayed between the person 1 and the displayed object image 7 (Step 708).

The operation from a physical object to the real space S can be referred to also as an operation that expands the real world to a virtual world expressed by an image. Alternatively, it can be referred to also as an operation of pulling out content or the like to a virtual world.

Various types of image display may be executable as image display corresponding to the operation of the string image 15 connected to a physical object. As a result, it is possible to provide new user experience with high quality in various variations. Examples of variations are listed below.

It is possible to pull out content or the like displayed on an actual display device.

It is possible to pull out the light of the lighting apparatus 3 and use it as a virtual light source.

By operating the string image 15 connected to a skylight or the like, it is possible to display an image imitating the sun as a virtual light source.

It is possible to pull out a captured image displayed in a digital photo frame. Note that in the case where information regarding a captured image displayed in the digital photo frame cannot be acquired, such processing that the sensor unit 20 physically imaging a captured image displayed in the digital photo frame to duplicate it and the duplicated image is displayed on the wall surface 5 or the like is possible.

[Collective Display of Object Image]

FIG. 17 is a schematic diagram describing collective display of a plurality of object images 7.

In the example shown in Part A of FIG. 17, the object image 7a is associated with the person 1a and the string image 15a is displayed. Further, the object image 7b is associated with the person 1b and the string image 15b is displayed.

The person 1a and the object image 7a correspond to one embodiment of the first person and the first object image according to the present technology. The person 1b and the object image 7b correspond to one embodiment of the second person and the second object image according to the present technology. The application of the “first” and “second” can be reversed.

As shown in Part B of FIG. 17, in the case where the distance between the person 1a and the person 1b is smaller than a predetermined threshold value, the object image 7 associated with the person 1a and the object image 7b associated with the person 1b are collectively displayed.

For example, as shown in Part B of FIG. 17, one collectively-displayed image is enlarged and displayed as an object image 7c. Both the person 1a and the person 1b are associated with the object image 7c.

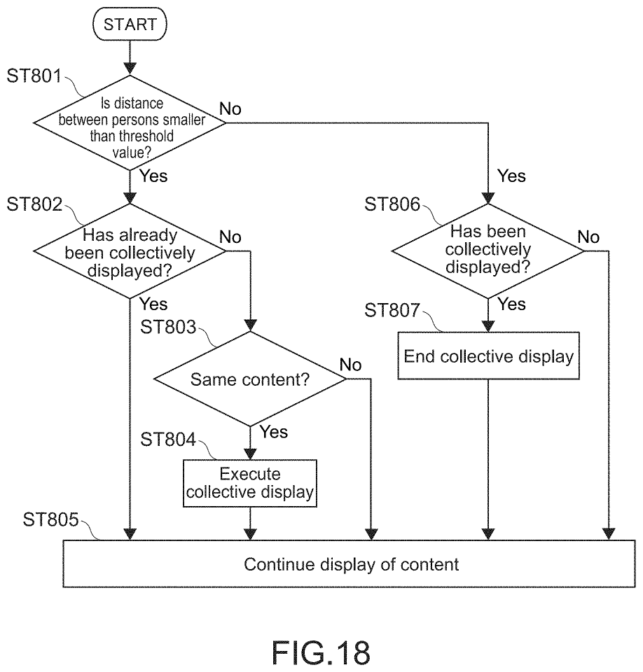

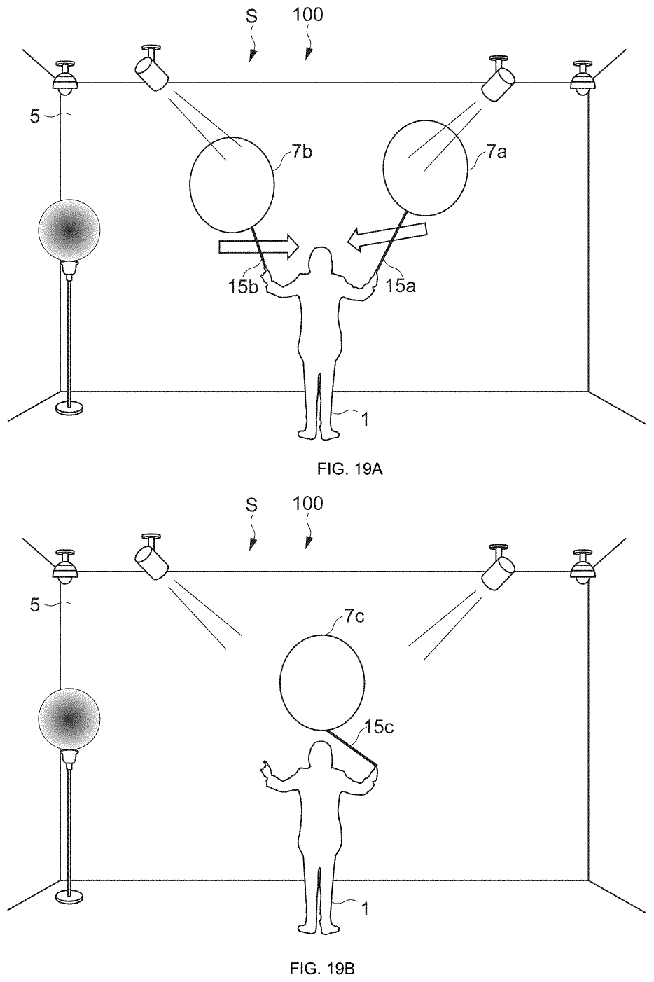

FIG. 18 is a flowchart showing a processing example of collective display. The processing shown in FIG. 18 is executed on a plurality of persons with which a content image is associated.

Whether or not the distance between persons is smaller than a predetermined threshold value is determined (Step 801).

In the case where the distance between persons is smaller than a threshold value (Yes in Step 801), whether or not collective display has already been executed is determined (Step 802).

In the case where collective display has not been executed (No in Step 802), whether or not they are the same content is determined (Step 803). For example, referring to FIG. 17, whether or not the content image (the object image 7a) associated with the person 1a and the content image (the object image 7b) associated with the person 1b are the same content image is determined.

In the case where they are the same content (Yes in Step 803), collective display is executed (Step 804). For example, a common content image is displayed as the collectively-displayed image (the object image 7c) shown in Part B of FIG. 17. Then, with the collectively-displayed image, display of content is continued (Step 805).

In the case where they are not the same content (No in Step 803), collective display is not executed and display of content is continued with each of a content image (the object image 7a) and a content image (the object image 7b) (Step 805).

In the case where the distance between persons is not smaller than the threshold value (No in Step 801), whether or not collective display has been executed is determined (Step 806).

In the case where collective display has been executed (Yes in Step 806), collective display is finished (Step 807). That is, it is separated into a content image (the object image 7a) and a content image (the object image 7b). Then, display of content is continued in this state (Step 805).

In the case where collective display has not been executed (No in Step 806), with each of a content image (the object image 7a) and a content image (the object image 7b), display of content is continued (Step 805).

As a method for collective display, an arbitrary method may be executed. For example, a plurality of images different from each other may be displayed in one frame image and one collectively-displayed image may be configured as a whole. In this case, collective display is possible even if they are not the same content image.

Further, collectively display may be executed on the object image 7 whose type is different from that of a content image.

The display position, size, and the like of the collectively-displayed image are also not limited. For example, the size that all of a plurality of persons 1 can properly use a content image, the display position and size that all of the plurality of persons 1 can properly access the apparatus control image, and the like only need to be appropriately calculated.

The condition and trigger for executing collective display are also not limited. Collective display may be executed in the case where an instruction to perform collective display has been input from the person 1. Further, collective display may be executed in the case where the person 1a and the person 1b have made movements of causing the object images 7 associated therewith to collide with each other.

[Display of Integrated Information]

FIG. 19 is a schematic diagram describing display of integrated information.

In the example shown in FIG. 19, a plurality of object images 7 is associated with the person 1. Specifically, the object image 7a and the object image 7b are associated with each other. The object image 7a and the object image 7b correspond to one embodiment of the first object image and the second object image according to the present technology.

As illustrated in Parts A and B of FIG. 19, the person 1 operates the string images 15a and 15b to superimpose the object image 7a and the object image 7b associated with the person 1 on each other. As a result, integrated information regarding the object image 7a and the object image 7b is displayed as the object image 7c. The integrated information is information integrating the content of the object image 7a and the content of the object image 7b.

One string image 15c is displayed between the person 1 and the object image 7c. The string image 15c can be regarded also as the string image 15 integrating the string images 15a and 15c.

As described above, it is possible to display, in the real space S, integrated information regarding the object image 7a and the object image 7b as an object associated with the person 1, on the basis of the movement of the person 1 operating the string images 15a and 15b to superimpose the object image 7a and the object image 7b associated with the person 1 on each other.

The operation of displaying integrated information by superimposing a plurality of object images can be referred to also as an operation of integrating information and information to acquire integrated information.

Various variations can be considered as to what kind of integrated information is displayed by superimposing what kind of object image 7.

For example, the image displayed as the object image 7b is superimposed on the object image 7a displaying a Web page of a search site. As a result, the image search result of the image displayed as the object image 7b is displayed as integrated information.

For example, the image displayed as the object image 7b is superimposed on the object image 7a displayed on a Web page including information regarding a predetermined painter. As a result, the image displayed as the object image 7b is processed in the style of the painter's work included in the object image 7a and displayed as integrated information.

The object image 7a including a food stuff A and the object image 7b including the national flag of a certain country are superimposed on each other. As a result, the recipe of the specialty dish of the country using the food stuff A is displayed as integrated information.

The processing method (combination of integration, etc.) for generating integrated information is stored as, for example, the execution processing information 43. Processing for generating original integrated information for the person 1 may be registerable. In addition, various types of integrated information may be generated and displayed. As a result, it is possible to provide new user experience with high quality in various variations.

As described above, in the image display system 100 and the information processing apparatus 30 according to this embodiment, display of an association image is controlled, the association image making it possible for the person 1 to understand the association between the person 1 and an object and how the object is affected by the movement of the person 1. As a result, it is possible to realize new user experience.

In the case where a plurality of images presenting information or the like is displayed and also a plurality of persons (users) is present, for whom an image is displayed cannot be understood. Further, in the case where an image is movable, it is difficult to present the mobility characteristics to a person.

Since it is difficult to present mobility characteristics, appropriate adjustment is difficult in the case where a person tries to operate the position of the image by a gesture or the like.

In this embodiment, it is possible to clearly show the relationship between an image or a physical object and the person 1 to the person 1, by connecting the virtual string image 15 to the person 1. Further, it is also possible to present the degree of follow-up of the image by tension expression of the string image 15.

Further, for example, it is possible to execute various types of processing by operating the string image 15 by a gesture such as pulling and causing the object image 7 connected to the tip to collide with an object such as an electronic apparatus. Further, it is also possible to pull out information regarding a physical object connected to the tip of the string image 15 and display it. Further, for example, it is also possible to present integrated information by causing those connected to the tips of the string image 15 to collide with each other.

As described above, it is possible to clearly show the relationship, clearly show the mobility characteristics and realize the interaction between a physical object and a virtual space.

### Other Embodiments

The present technology is not limited to the embodiment described above, and various other embodiments can be realized.

Regarding the association between the person 1a and the television set 2 shown in FIG. 15, a virtual object image of the television set 2 may be displayed at the tip of the string image 15a in response to the operation of causing the tip of the string image 15a to move. Then, the virtually displayed television set 2 may display an image regarding the television set 2.

As described above, in the case where the tip of the string image 15 is caused to move while the person 1 and an actual object are associated with each other by the string image 15, a virtual object image of an actual object that has been associated may be displayed as an object image. The association with the person 1 is changed from an actual object to a virtual object image. In the case where the actual object is an electronic apparatus or the like, such display control that the function of the electronic apparatus is exhibited by the virtual object image may be executed (e.g., image display by a display device).

As described above, the object image includes an arbitrary image displayed in the real space S. Therefore, an image (content image or the like) displayed by a display device disposed in the real space S is also included in the object image.

For example, the present technology can be implemented using the association between the person 1a and the television set 2 shown in FIG. 15 as the association between the person 1a and the object image displayed on the television set 2.

In this case, in response to the operation of causing the tip of the string image 15a to move, an image regarding the object image that has been displayed on the television set 2 is displayed as a new object image to be associated on the wall surface 5.

For example, in the case where an actual cat is displayed by the television set 2, as an object image, an image of the cat is associated with the person 1a. In the case where the person 1a has caused the tip of the string image 15a to move, a virtual object image 7a of a cat is displayed as an object image on the wall surface 5 and is associated with the person 1a. The association with the person 1a is changed from the image displayed on the television set 2 to the virtual object displayed on the wall surface 5.

The person 1a can perform an operation of pulling out content or the like in the television set 2 to the outside of the television set 2 and displaying it at a desired position, and new user experience is realized.

Note that various methods may be used as a method of detecting the content of an image displayed on a display device. For example, by executing object recognition on the image obtained by imaging the real space S including a display device, it is possible to determine what is displayed on the display device. It goes without saying that recognition or the like using a machine learning algorithm such as semantic segmentation and background subtraction may be executed. In addition, in the case where meta information such as a tag is added to an image displayed on the television set 2, the meta information may be appropriately referred to.

A transmissive HMD (Head Mounted Display) may be mounted on the head of the person 1 and the HMD may display the string image 15 on the real space S. That is, the present technology can be applied to AR space.

Further, a buried HMD may be mounted, and display control or the like of the string image 15 according to the present technology may be executed on VR (Virtual Reality) space.

As a method of expressing the string image 15, the string image 15 is displayed so as to crawl on the floor, the wall surface, or the like. The present technology is not limited thereto, and the string image 15 may be three-dimensionally expressed by an AR image or the like.

The string image 15 may be displayed so as to be connected from the first person viewpoint of the person 1. For example, it is possible to adopt an illusionary presentation method or the like.

Typically, the string image 15 connecting the person 1 and an object to each other is displayed such that the string image 15 can be viewed by another person 1. The present technology is not limited thereto, and such display control that it seems to be cut when viewed from another person 1 but it seems to be connected to the object when viewed from the person 1 himself/herself 1 may be executed.

Grouping of related items and the like may be executed by the branch expression of the string image 15.

Further, various animation expressions may be realized for the string image 15. Data communication or the like with an object may be expressed by such an expression that the string image 15 pulses.

Further, as an association image, an image other than the string image 15 may be displayed.

For example, by operating a haptic presentation apparatus capable of presenting a predetermined haptic sensation together, a haptic sensation or force received from an actual string object may be reproducible. For example, the reaction force received from the object image 7 may be reproduced by haptic presentation in accordance with the follow-up of the object image 7 as illustrated in FIG. 8. Further, a haptic sensation or the like may be presented to the person 1 in response to various operations of the string image 15 illustrated in FIG. 11 and he like. For example, vibration of the string image 15 can be realized. As a result, it is possible to realize user experience with high quality.

Further, it is also possible to induce a predetermined movement of the person 1 by giving a weak electrical signal to a predetermined muscle of the person 1. As a result, for example, it is also possible to realize the feeling of being pulled from the string image 15.

As a haptic presentation apparatus, a portable terminal such as a smartphone, a wearable device that can be worn by the person 1, or the like can be adopted. For example, various types of wearable devices such as a wristband type, a bracelet type, and a neckband type can be adopted.

FIG. 20 is a block diagram showing a hardware configuration example of the information processing apparatus 30.

The information processing apparatus 30 includes a CPU 201, a ROM 202, a RAM 203, an input/output interface 205, and a bus 204 connecting them to each other.

A display unit 206, an input unit 207, a storage unit 208, a communication unit 209, a drive unit 210, and the like are connected to the input/output interface 205.

The display unit 206 is, for example, a display device using liquid crystal, EL, or the like.

The input unit 207 is, for example, a keyboard, a pointing device, a touch panel, or another operating device. In the case where the input unit 207 includes a touch panel, the touch panel can be integrated with the display unit 206.

The storage unit 208 is a non-volatile storage device, and is, for example, an HDD, a flash memory, or another solid-state memory.

The drive unit 210 is, for example, a device capable of driving a removable recoding medium 211 such as an optical recording medium and a magnetic recording tape.

The communication unit 209 is a modem, router, or another communication device for communicating with another device, which can be connected to a LAN, WAN, or the like. The communication unit 209 may be one that performs wired or wirelessly communication. The communication unit 209 is often used separately from the information processing apparatus 30.

The information processing by the information processing apparatus 30 having the hardware configuration described above is realized by the cooperation of software stored in the storage unit 208, the ROM 202, or the like and hardware resources of the information processing apparatus 30.

Specifically, the information processing method according to the present technology is realized by loading the program configuring software stored in the ROM 202 or the like into the RAM 203 and executing the program.

The program is installed in the information processing apparatus 30 via, for example, the recording medium 211. Alternatively, the program may be installed in the information processing apparatus 30 via a global network or the like. In addition, an arbitrary computer-readable non-transient storage medium may be used.

The information processing apparatus according to the present technology may be configured and the information processing method and the program according to the present technology may be executed by a plurality of computers communicably connected via a network or the like.

That is, the information processing method and the program according to the present technology can be executed not only in a computer system configured by a single computer but also in a computer system in which a plurality of computers operates in conjunction with each other.

Note that in the present disclosure, the system means a set of a plurality of components (devices, modules parts), etc.), and all the components do not necessarily need to be in the same casing. Therefore, a plurality of devices that is housed in separate casings and connected to each other via a network, and one device in which a plurality of modules is housed in one casing are both systems.

The execution of the information processing method and the program according to the present technology by a computer system includes, for example, both the case where acquisition of space-related information, display control of a string image, display control of an object image, execution of various types of processing, and the like are executed by a single computer and the case where each type of processing is executed by different computers.

Further, execution of each type of processing by a predetermined computer includes causing another computer to execute part or all of the processing and acquiring the result thereof.

That is, the information processing method and the program according to the present technology are applicable also to a configuration of cloud computing in which a plurality of apparatuses shares and collaboratively processes a single function via a network.

Each configuration of the image display system, the image display unit, the sensor unit, the information processing apparatus, and the like, acquisition of space-related information, environment recognition, person recognition, display control of a string image, processing flow of execution of various types of processing, and the like described with reference to the drawings are merely an embodiment, and can be arbitrarily modified without departing from the essence of the present technology. In other words, for example, other arbitrary configurations or algorithms for implementing the present technology may be adopted.

Of the feature portions according to the present technology described above, at least two feature portions can be combined. That is, the various characteristic portions described in the respective embodiments may be arbitrarily combined without distinguishing from each other in the respective embodiments. It should be noted that the effects described above are merely illustrative and are not limitative, and may have an additive effect.

Note that the present technology may also take the following configurations.

(1) An information processing apparatus, including:

a display control unit that controls, on a basis of space-related information regarding a real space, display of an association image on the real space, the association image making it possible for a person in the real space to understand association of the person with an object in the real space and how the object is affected by movement of the person.

(2) The information processing apparatus according to (1), in which

the space-related information includes movement information regarding the movement of the person in the real space, and

the display control unit controls the display of the association image on a basis of the movement information.

(3) The information processing apparatus according to (1) or (2), further including

a determination unit that determines an instruction from the person in the real space, in which

the image display unit controls the display of the association image on a basis of the instruction.

(4) The information processing apparatus according to any one of (1) to (3), in which

the association image includes a string-shaped image displayed so as to connect the person and the object with each other.

(5) The information processing apparatus according to (4), in which

the string-shaped image is an image imitating an actual string object having a defined length.

(6) The information processing apparatus according to (4) or (5), in which

the space-related information includes position information of the person and position information of the object, and

the display control unit controls a display mode of the string-shaped image on a basis of a distance between the person and the object.

(7) The information processing apparatus according to any one of (4) to (6), in which

the display control unit displays the string-shaped image such that the string-shaped image is tighter as the distance between the person and the object increases and displays the string-shaped image such that the string-shaped image is looser as the distance between the person and the object decreases.

(8) The information processing apparatus according to any one of (4) to (7), in which

the space-related information includes position information of the person and position information of the object, and

the display control unit calculates, on a basis of a position of the person and a position of the object, a position of a first endpoint of the string-shaped image on a side of the person and a position of a second endpoint of the string-shaped image on a side of the object, and displays the string-shaped image such that the first endpoint and the second endpoint are connected to each other.

(9) The information processing apparatus according to any one of (4) to (8), in which

the object includes an object image that is an image displayed in the real space, and

the display control unit is capable of controlling display of the object image and causes, where the person has moved in a direction away from the object image while the string-shaped image is fully stretched, the object image to move so as to follow the movement of the person.

(10) The information processing apparatus according to any one of (4) to (9), in which

the display control unit causes the object image to move on a basis of the movement of the person operating the string-shaped image.

(11) The information processing apparatus according to any one of (4) to (10), further including

a processing execution unit that executes processing regarding the object associated with the person.

(12) The information processing apparatus according to (11), further including

a determination unit that determines an instruction from the person in the real space, in which

the processing execution unit executes, on a basis of the instruction from the person in the real space, processing regarding the object associated with the person who has input the instruction.

(13) The information processing apparatus according to (11) or (12), in which

the space-related information includes apparatus information regarding an electronic apparatus in the real space,

the object includes an object image that is an image displayed in the real space, and

the processing execution unit controls the electronic apparatus on a basis of the movement of the person operating the string-shaped image to superimpose the object image on the electronic apparatus.

(14) The information processing apparatus according to (13), in which

the electronic apparatus includes a display device, and

the processing execution unit causes, on a basis of the movement of superimposing the object image on the display device, the display device to display an image regarding the object image.

(15) The information processing apparatus according to any one of (11) to (14), in which

the space-related information includes object information regarding an object in the real space, and

the display control unit displays, in the real space, the object information regarding the object associated with the person.

(16) The information processing apparatus according to any one of (11) to (15), in which

the space-related information includes apparatus information regarding an electronic apparatus in the real space, and

the display control unit displays, in the real space, an image regarding the electronic apparatus as the object associated with the person, on a basis of movement of causing a tip of the string-shaped image displayed so as to connect the person and the electronic apparatus to each other to move from the electronic apparatus to another position.

(17) The information processing apparatus according to any one of (4) to (16), in which

the object includes an object image that is an image displayed in the real space, and

the display control unit collectively displays, where a distance between a first person and a second person in the real space is smaller than a predetermined threshold value, a first object image associated with the first person and a second object image associated with the second person.

(18) The information processing apparatus according to any one of (4) to (17), in which

the display control unit is capable of controlling, where a plurality of objects is associated with the person, display of a plurality of string-shaped images connecting the person and the plurality of objects to each other,

the object includes an object image that is an image displayed in the real space, and

the display control unit displays, in the real space, integrated information regarding the first object image and the second object image as the object associated with the person, on a basis of the movement of the person operating the plurality of string-shaped images to superimpose the first object image and the second object image associated with the person on each other.

(19) An information processing method executed by a computer system, including:

controlling, on a basis of space-related information regarding a real space, display of an association image on the real space, the association image making it possible for a person in the real space to understand association of the person with an object in the real space and how the object is affected by movement of the person.

(20) A program that causes a computer system to execute the following step of:

controlling, on a basis of space-related information regarding a real space, display of an association image on the real space, the association image making it possible for a person in the real space to understand association of the person with an object in the real space and how the object is affected by movement of the person.

(21) The information processing apparatus according to any one of (1) to (18), in which

the space-related information includes information regarding a display restriction area in which display of an image in the real space is restricted, and

the display control unit fixes the object image that moves toward the display restriction area at a position immediately before the display restriction area.

(22) The information processing apparatus according to any one of (4) to (18), in which

the object is an object in the real space, and

the display control unit displays, where the person has moved in a direction away from the object while the string-shaped image is fully stretched, the string-shaped image such that the string-shaped image is cut.

(23) The information processing apparatus according to (13), in which

the object image includes at least one of a function image regarding a function of the electronic apparatus or a status image regarding a status of the electronic apparatus.

(24) The information processing apparatus according to (16), in which

an image regarding the electronic apparatus includes an image virtually displaying the electronic apparatus.

(25) The information processing apparatus according to (14), in which

the object image includes an image displayed on the display device, and

the display control unit displays, in the real space, an image regarding the image that has been displayed on the display device as an object associated with the person, on the basis of movement of causing a tip of the string-shaped image displayed so as to connect the person and the display device to each other to move from the display device to another position.

### REFERENCE SIGNS LIST

P1 first endpoint
P2 second endpoint
1 person 1
2 television set
3 lighting apparatus
4 electronic piano
7 object image
8 foliage plant
10 image display unit
15 string image
20 sensor unit
26 interlocking device
30 information processing apparatus
31 display control unit
32 space-related information
36 device control unit
42 object information
45 object
47 display restriction area
100 image display system

1. An information processing apparatus, comprising:
a display control unit that controls, on a basis of space-related information regarding a real space, display of an association image on the real space, the association image making it possible for a person in the real space to understand association of the person with an object in the real space and how the object is affected by movement of the person.

2. The information processing apparatus according to claim 1, wherein
the space-related information includes movement information regarding the movement of the person in the real space, and
the display control unit controls the display of the association image on a basis of the movement information.

3. The information processing apparatus according to claim 1, further comprising
a determination unit that determines an instruction from the person in the real space, wherein
the image display unit controls the display of the association image on a basis of the instruction.

4. The information processing apparatus according to claim 1, wherein
the association image includes a string-shaped image displayed so as to connect the person and the object with each other.

5. The information processing apparatus according to claim 4, wherein
the string-shaped image is an image imitating an actual string object having a defined length.

6. The information processing apparatus according to claim 4, wherein
the space-related information includes position information of the person and position information of the object, and
the display control unit controls a display mode of the string-shaped image on a basis of a distance between the person and the object.

7. The information processing apparatus according to claim 4, wherein
the display control unit displays the string-shaped image such that the string-shaped image is tighter as the distance between the person and the object increases and displays the string-shaped image such that the string-shaped image is looser as the distance between the person and the object decreases.

8. The information processing apparatus according to claim 4, wherein
the space-related information includes position information of the person and position information of the object, and
the display control unit calculates, on a basis of a position of the person and a position of the object, a position of a first endpoint of the string-shaped image on a side of the person and a position of a second endpoint of the string-shaped image on a side of the object, and displays the string-shaped image such that the first endpoint and the second endpoint are connected to each other.

9. The information processing apparatus according to claim 4, wherein
the object includes an object image that is an image displayed in the real space, and
the display control unit is capable of controlling display of the object image and causes, where the person has moved in a direction away from the object image while the string-shaped image is fully stretched, the object image to move so as to follow the movement of the person.

10. The information processing apparatus according to claim 4, wherein
the display control unit causes the object image to move on a basis of the movement of the person operating the string-shaped image.

11. The information processing apparatus according to claim 4, further comprising
a processing execution unit that executes processing regarding the object associated with the person.

12. The information processing apparatus according to claim 11, further comprising
a determination unit that determines an instruction from the person in the real space, wherein
the processing execution unit executes, on a basis of the instruction from the person in the real space, processing regarding the object associated with the person who has input the instruction.

13. The information processing apparatus according to claim 11, wherein
the space-related information includes apparatus information regarding an electronic apparatus in the real space,
the object includes an object image that is an image displayed in the real space, and
the processing execution unit controls the electronic apparatus on a basis of the movement of the person operating the string-shaped image to superimpose the object image on the electronic apparatus.

14. The information processing apparatus according to claim 13, wherein
the electronic apparatus includes a display device, and
the processing execution unit causes, on a basis of the movement of superimposing the object image on the display device, the display device to display an image regarding the object image.

15. The information processing apparatus according to claim 11, wherein
the space-related information includes object information regarding an object in the real space, and
the display control unit displays, in the real space, the object information regarding the object associated with the person.

16. The information processing apparatus according to claim 11, wherein
the space-related information includes apparatus information regarding an electronic apparatus in the real space, and
the display control unit displays, in the real space, an image regarding the electronic apparatus as the object associated with the person, on a basis of movement of causing a tip of the string-shaped image displayed so as to connect the person and the electronic apparatus to each other to move from the electronic apparatus to another position.

17. The information processing apparatus according to claim 4, wherein
the object includes an object image that is an image displayed in the real space, and
the display control unit collectively displays, where a distance between a first person and a second person in the real space is smaller than a predetermined threshold value, a first object image associated with the first person and a second object image associated with the second person.

18. The information processing apparatus according to claim 4, wherein
the display control unit is capable of controlling, where a plurality of objects is associated with the person, display of a plurality of string-shaped images connecting the person and the plurality of objects to each other,
the object includes an object image that is an image displayed in the real space, and
the display control unit displays, in the real space, integrated information regarding the first object image and the second object image as the object associated with the person, on a basis of the movement of the person operating the plurality of string-shaped images to superimpose the first object image and the second object image associated with the person on each other.

19. An information processing method executed by a computer system, comprising:
controlling, on a basis of space-related information regarding a real space, display of an association image on the real space, the association image making it possible for a person in the real space to understand association of the person with an object in the real space and how the object is affected by movement of the person.

20. A program that causes a computer system to execute the following step of:
controlling, on a basis of space-related information regarding a real space, display of an association image on the real space, the association image making it possible for a person in the real space to understand association of the person with an object in the real space and how the object is affected by movement of the person.
